(19) United States
(12) Patent Application Publication
(10) Pub. No.: US 2013/0066452 A1
(43) Pub. Date: Mar. 14, 2013

(54) INFORMATION PROCESSING DEVICE, ESTIMATOR GENERATING METHOD AND PROGRAM

(71) Applicants: Yoshiyuki KOBAYASHI, Tokyo (JP); Tamaki Kojima, Tokyo (JP)

(72) Inventors: Yoshiyuki KOBAYASHI, Tokyo (JP); Tamaki Kojima, Tokyo (JP)

(21) Appl. No.: 13/591,520

(22) Filed: Aug. 22, 2012

(30) Foreign Application Priority Data
Sep. 8, 2011 (JP) 2011-196300
Sep. 8, 2011 (JP) 2011-196301

(51) Int. Cl. G06F 17/00

(52) U.S. Cl. 700/94

(57) ABSTRACT

Provided is an information processing device including a feature quantity vector calculation section that, when a plurality of pieces of learning data each configured including input data and an objective variable corresponding to the input data are given, inputs the input data into a plurality of basis functions to calculate feature quantity vectors which include output values from the respective basis functions as elements, a distribution adjustment section that adjusts a distribution of points which are specified by the feature quantity vectors in a feature quantity space so that the distribution of the points becomes closer to a predetermined distribution, and a function generation section that generates an estimation function which outputs an estimate value of the objective variable in accordance with input of the feature quantity vectors with respect to the plurality of pieces of learning data.

### BACKGROUND

The present technology relates to an information processing device, an estimator generating method and a program.

In recent years, a method is gaining attention that is for automatically extracting, from an arbitrary data group for which it is difficult to quantitatively determine a feature, a feature quantity of the data group. For example, a method of taking arbitrary music data as an input and automatically constructing an algorithm for automatically extracting the music genre to which the music data belongs is known. The music genres, such as jazz, classics and pops, are not quantitatively determined according to the type of instrument or performance mode. Accordingly, in the past, it was generally considered difficult to automatically extract the music genre from music data when arbitrary music data was given.

However, in reality, features that separate the music genres are potentially included in various combinations of information items such as a combination of pitches included in music data, a manner of combining pitches, a combination of types of instruments, and a structure of a melody line or a bass line. Accordingly, a study of a feature quantity extractor has been conducted with regard to the possibility of automatic construction, by machine learning, of an algorithm for extracting such feature (hereinafter, referred to as, feature quantity extractor). As one study result, there can be cited an automatic construction method, described in JP-A-2009-48266, of a feature quantity extractor based on a genetic algorithm. The genetic algorithm is an algorithm that mimics the biological evolutionary process and takes selection, crossover and mutation into consideration in the process of machine learning.

By using the feature quantity extractor automatic construction algorithm described in the patent document mentioned above, a feature quantity extractor for extracting, from arbitrary music data, a music genre to which the music data belongs can be automatically constructed. Also, the feature quantity extractor automatic construction algorithm described in the patent document is highly versatile and is capable of automatically constructing a feature quantity extractor for extracting, not only from the music data but also from arbitrary data group, a feature quantity of the data group. Accordingly, the feature quantity extractor automatic construction algorithm described in the patent document is expected to be applied to feature quantity analysis of artificial data such as music data and image data and feature quantity analysis of various observation quantities existing in nature.

### SUMMARY

The feature quantity extractor automatic construction algorithm described in the above mentioned document uses the previously prepared learning data to automatically construct a feature quantity extraction formula. The larger number of learning data results in the higher performance of the automatically constructed feature quantity extraction formula. However, the size of memory available for constructing the feature quantity extraction formula is limited. Also, when the number of learning data is large, a higher calculation performance is necessary for achieving the construction of the feature quantity extraction formula. Therefore, a configuration which preferentially uses useful learning data contributing to enhance the performance of the feature quantity extraction formula from the learning data which are supplied in large quantity is expected. By achieving such configuration, a feature quantity extraction formula with a higher accuracy can be obtained. Therefore, it is expected to enhance the performance of the estimator which uses the feature quantity extraction formula to estimate a result.

The present technology has been worked out under the above-described circumstances. The present technology intends to provide a novel and improved information processing device, an estimator generating method and a program which are capable of generating a higher performance estimator.

According to an aspect of the present technology, provided is an information processing device, which includes: a feature quantity vector calculation section that, when a plurality of pieces of learning data each configured including input data and an objective variable corresponding to the input data are given, inputs the input data into a plurality of basis functions to calculate feature quantity vectors which include output values from the respective basis functions as elements; a distribution adjustment section that adjusts a distribution of points which are specified by the feature quantity vectors in a feature quantity space so that the distribution of the points becomes closer to a predetermined distribution; and a function generation section that generates an estimation function which outputs an estimate value of the objective variable in accordance with input of the feature quantity vectors with respect to the plurality of pieces of learning data.

Also, according to another an aspect of the present technology, provided is an estimator generating method, which includes: inputting, when a plurality of pieces of learning data each configured including input data and objective variables corresponding to the input data are given, the input data into a plurality of basis functions to calculate feature quantity vectors which include output values from the respective basis functions as elements; adjusting a distribution of points which are specified by the feature quantity vectors in a feature quantity space so that the distribution of the points becomes closer to a predetermined distribution; and generating an estimation function which outputs estimate values of the objective variables in accordance with input of the feature quantity vectors with respect to the plurality of pieces of learning data.

Also, according to still another an aspect of the present technology, provided is a program for causing a computer to realize: a feature quantity vector calculation function that, when a plurality of pieces of learning data each configured including input data and an objective variable corresponding to the input data are given, inputs the input data into a plurality of basis functions to calculate feature quantity vectors which include output values from the respective basis functions as elements; a distribution adjustment function that adjusts a distribution of points which are specified by the feature quantity vectors in a feature quantity space so that the distribution of the points becomes closer to a predetermined distribution; and a function generation function that generates an estimation function which outputs an estimate value of the objective variable in accordance with input of the feature quantity vectors with respect to the plurality of pieces of learning data.

Another aspect of the present technology is to provide a computer readable recording medium in which the above-described program is stored.

As described above, the present technology makes it possible to generate a higher performance estimator.

### BRIEF DESCRIPTION OF THE DRAWINGS

FIG. 1 is a diagram illustrating a system configuration for estimating a result by utilizing an estimator which is constructed by machine learning;

FIG. 2 is a diagram illustrating a configuration of a learning data used for estimator construction;

FIG. 3 is a diagram illustrating a structure of the estimator;

FIG. 4 is a flowchart illustrating a construction method of the estimator;

FIG. 5 is a flowchart illustrating a construction method of the estimator;

FIG. 6 is a flowchart illustrating a construction method of the estimator;

FIG. 7 is a flowchart illustrating a construction method of the estimator;

FIG. 8 is a flowchart illustrating a construction method of the estimator;

FIG. 9 is a flowchart illustrating a construction method of the estimator;

FIG. 10 is a flowchart illustrating a construction method of the estimator;

FIG. 11 is a flowchart illustrating a construction method of the estimator;

FIG. 12 is a flowchart illustrating a construction method of the estimator;

FIG. 13 is a diagram illustrating online learning;

FIG. 14 is a diagram showing the problems to be solved with respect to the construction method of the estimator based on the offline learning and the construction of estimator method based on the online learning;

FIG. 15 is a diagram illustrating a functional configuration of the information processing device according to the embodiment;

FIG. 16 is a diagram illustrating a detailed functional configuration of the estimation feature construction section according to the embodiment;

FIG. 17 is a diagram illustrating the relationship between the distribution of the learning data in a feature quantity space and the accuracy of estimator;

FIG. 18 is a diagram illustrating a relationship between the distribution of the learning data in a feature quantity space and the accuracy of estimator, and effect of online learning;

FIG. 19 is a diagram illustrating a method of sampling the learning data according to the embodiment;

FIG. 20 is a flowchart illustrating an efficient sampling method of the learning data according to the embodiment;

FIG. 21 is a diagram illustrating the efficient sampling method of the learning data according to the embodiment;

FIG. 22 is a diagram illustrating the efficient sampling method of the learning data according to the embodiment;

FIG. 23 is a diagram illustrating the efficient sampling method of the learning data according to the embodiment;

FIG. 24 is a diagram illustrating the efficient sampling method of the learning data according to the embodiment;

FIG. 25 is a diagram illustrating the efficient sampling method of the learning data according to the embodiment;

FIG. 26 is a diagram illustrating the efficient sampling method of the learning data according to the embodiment;

FIG. 27 is a flowchart illustrating an efficient weighting method according to the embodiment;

FIG. 28 is a diagram illustrating the efficient weighting method according to the embodiment;

FIG. 29 is a diagram illustrating the efficient weighting method according to the embodiment;

FIG. 30 is a diagram illustrating the efficient weighting method according to the embodiment;

FIG. 31 is a flowchart illustrating an efficient sampling/weighting method according to the embodiment;

FIG. 32 is a flowchart illustrating a selecting method of the learning data according to a modification of the embodiment;

FIG. 33 is a flowchart illustrating the selecting method of the learning data according to a modification of the embodiment;

FIG. 34 is a flowchart illustrating a weighting method of the learning data according to a modification of the embodiment;

FIG. 35 is a flowchart illustrating a selecting method of the learning data according to a modification of the embodiment;

FIG. 36 is a flowchart illustrating a weighting method of the learning data according to a modification of the embodiment;

FIG. 37 is a diagram illustrating a learning data generating method used for construction of an image recognizer;

FIG. 38 is a diagram illustrating a generating method of a learning data used for construction of a language analyzer;

FIG. 39 is a diagram illustrating an effect obtained by applying online learning; and

FIG. 40 is an illustration showing an example of hardware configuration capable of achieving the functions of the information processing device according to the embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

[Description Flow]

Here, flow of the following description will be briefly mentioned.

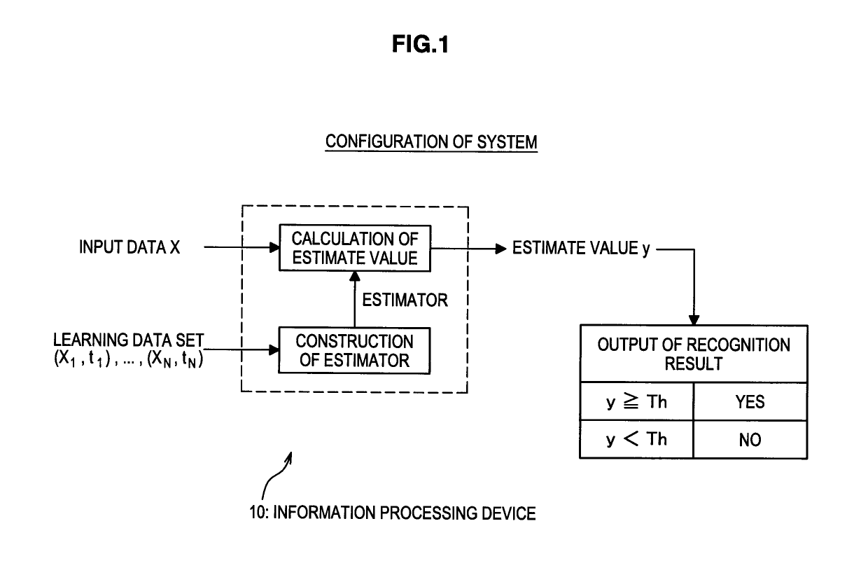

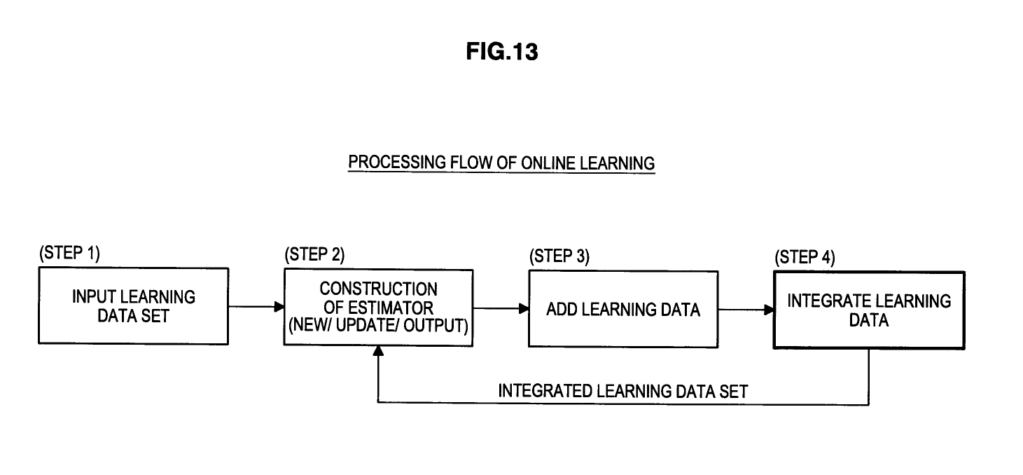

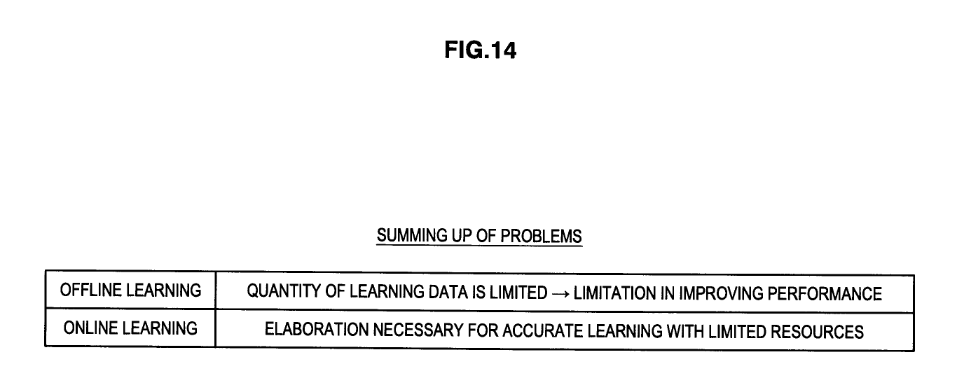

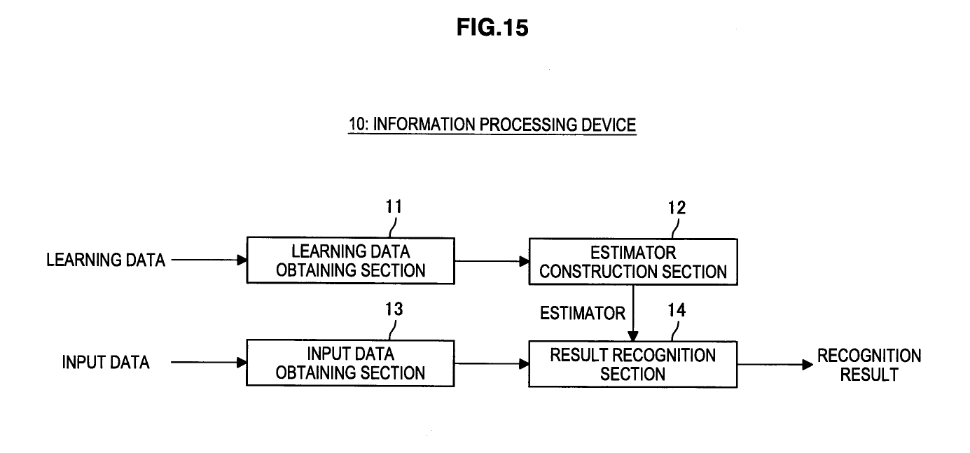

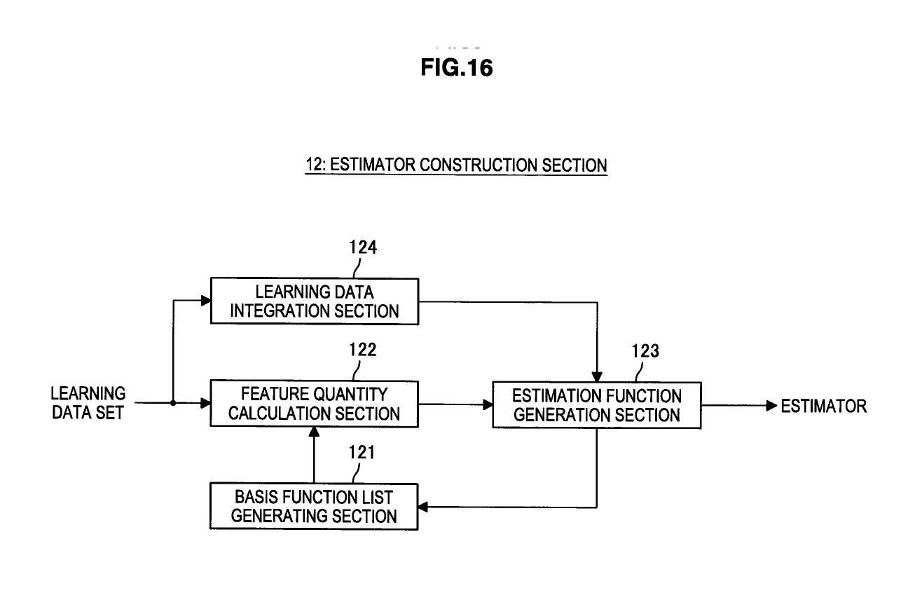

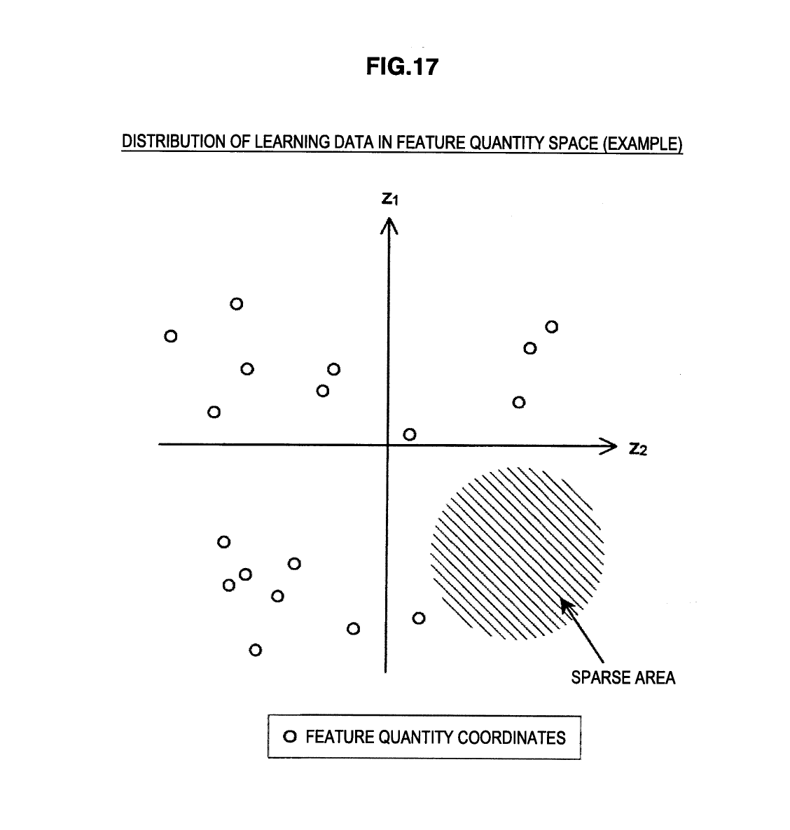

Referring to FIG. 1 through FIG. 12, an automatic construction method of an estimator will be described first. Subsequently, referring to FIG. 13 and FIG. 14, a description will be made on the automatic construction method based on online learning of the estimator. Subsequently, referring to FIG. 15 and FIG. 16, a description will be made on a functional configuration of an information processing device 10 according to the embodiment. Subsequently, referring to FIG. 17 through FIG. 19, a description will be made on the learning data integration method according to the embodiment.

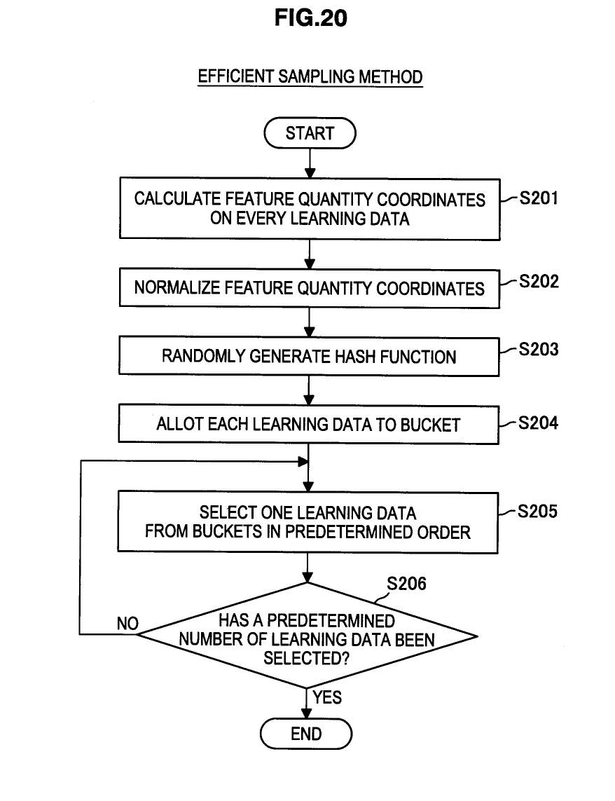

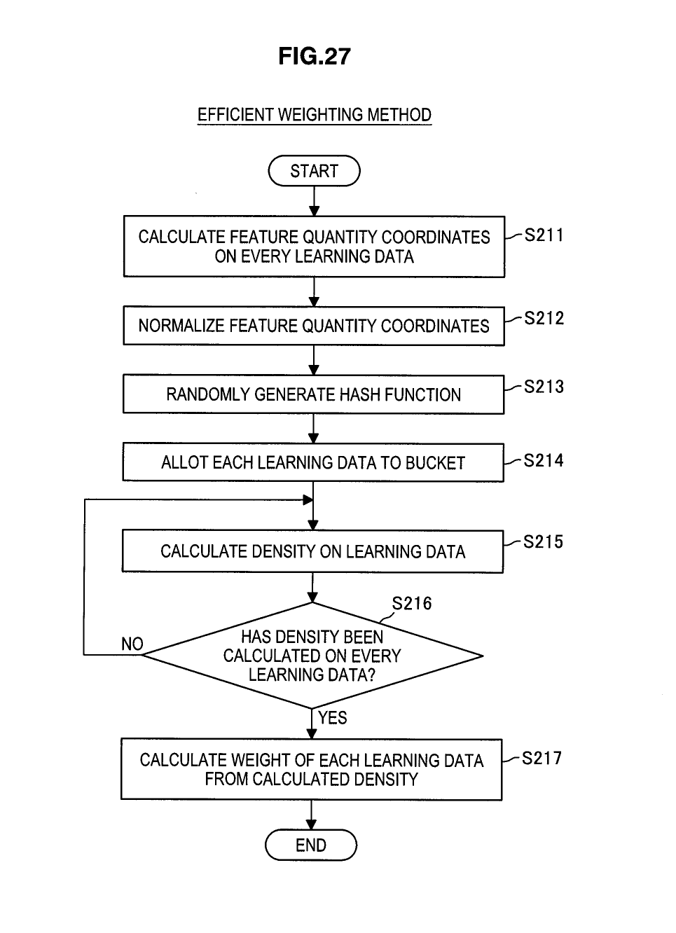

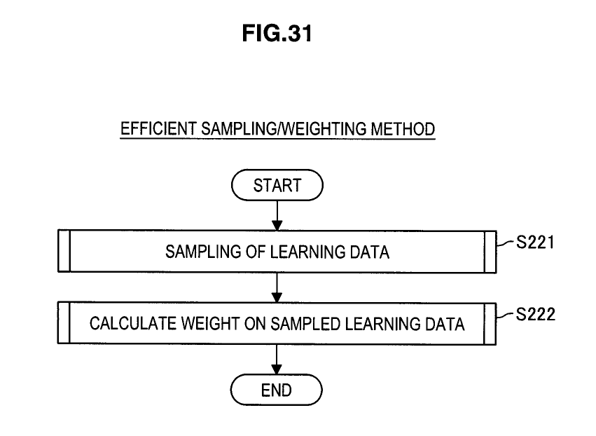

Subsequently, referring to FIG. 20 through FIG. 26, a description will be made on an efficient sampling method of learning data according to the embodiment. Subsequently, referring to FIG. 27 through FIG. 30, a description will be made on an efficient weighting method according to the embodiment. Subsequently, referring to FIG. 31, a description will be made on a combining method of an efficient sampling method and weighting method of learning data according to the embodiment.

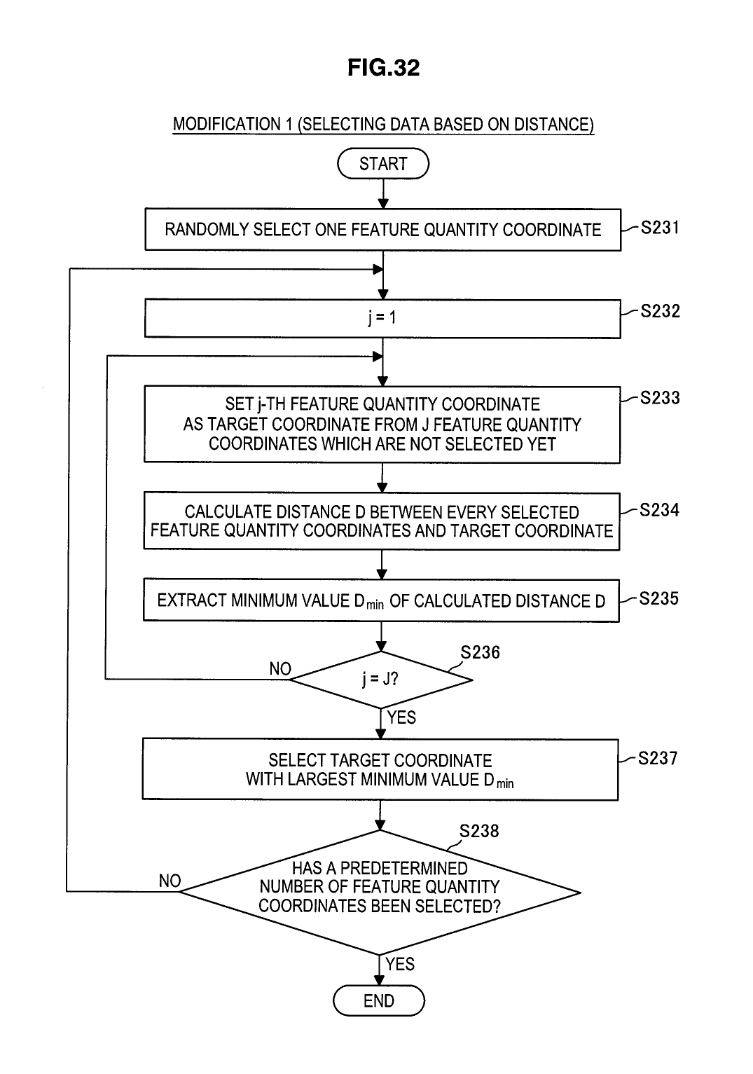

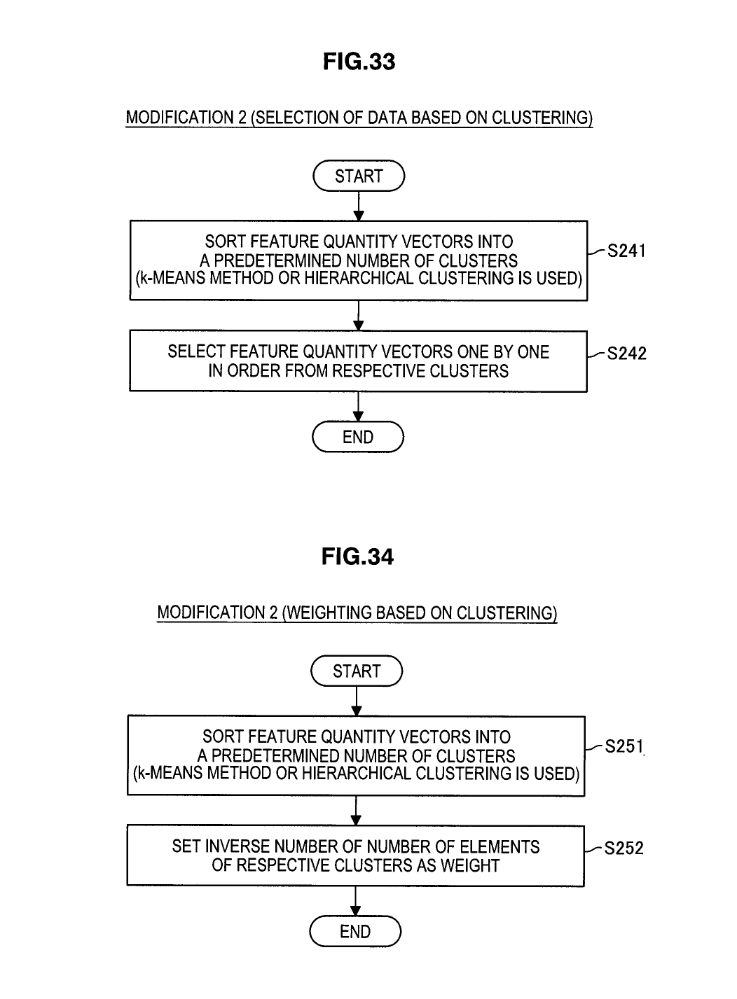

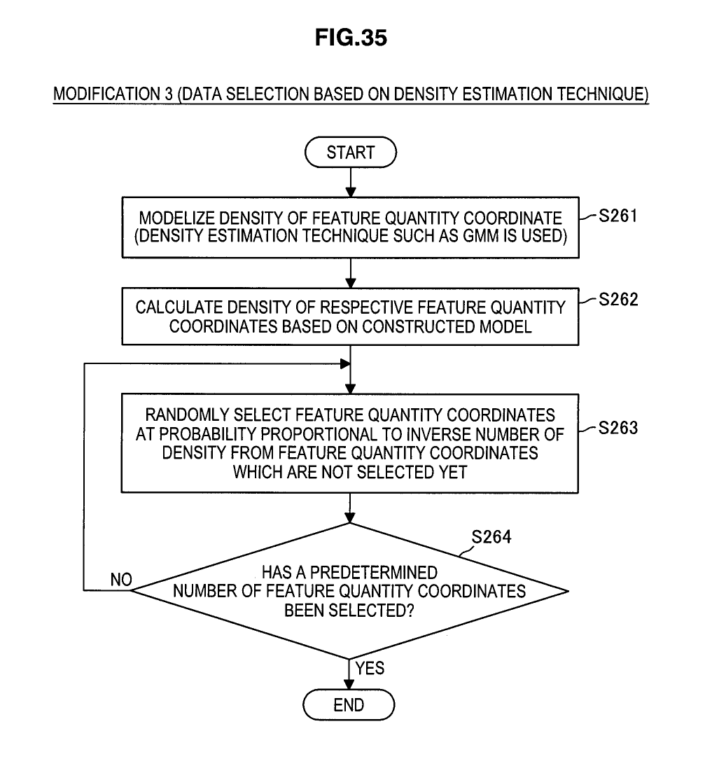

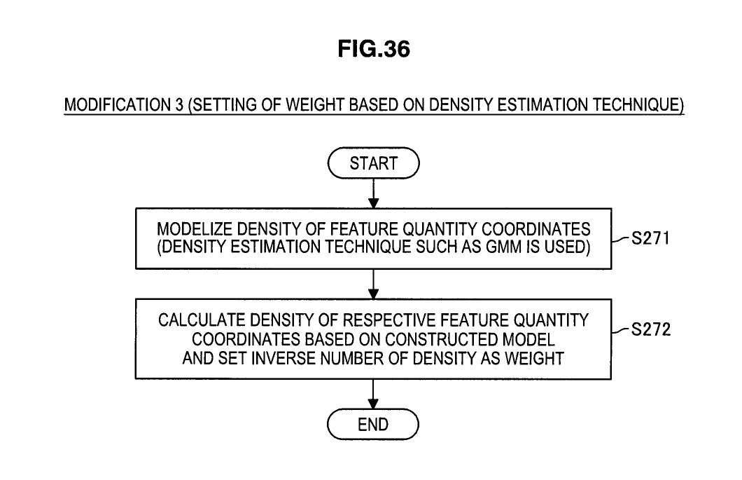

Subsequently, referring to FIG. 32, a description will be made on a sampling method of learning data according to a modification (modification 1) of the embodiment. Subsequently, referring to FIG. 33 and FIG. 34, a description will be made on a sampling method of learning data according to a modification (modification 2) of the embodiment. Subsequently, referring to FIG. 35 and FIG. 36, a description will be made on a sampling method of learning data according to a modification (modification 3) of the embodiment.

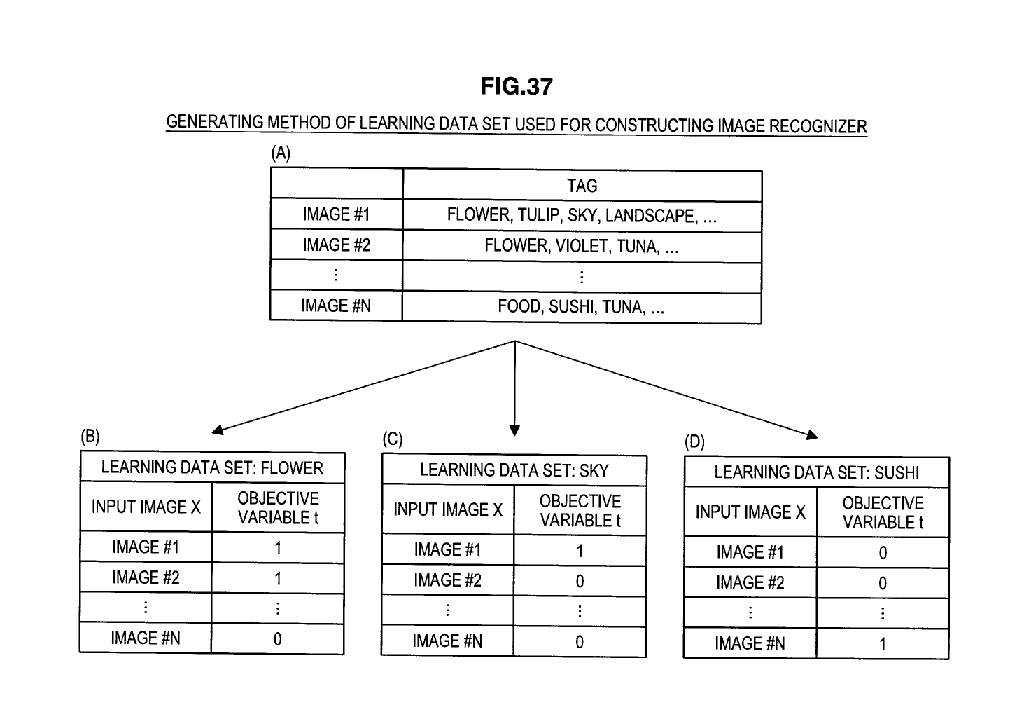

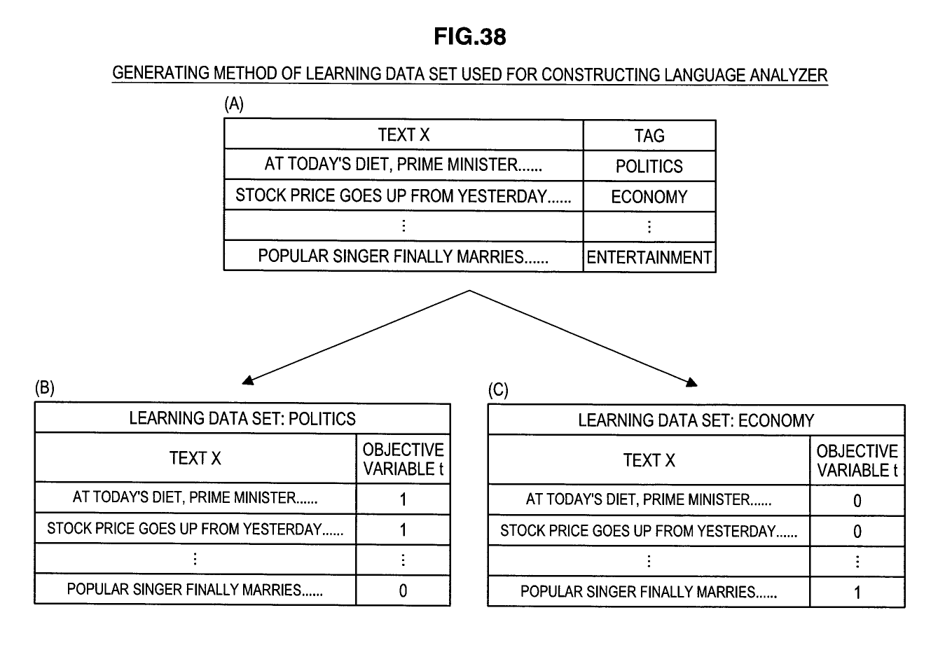

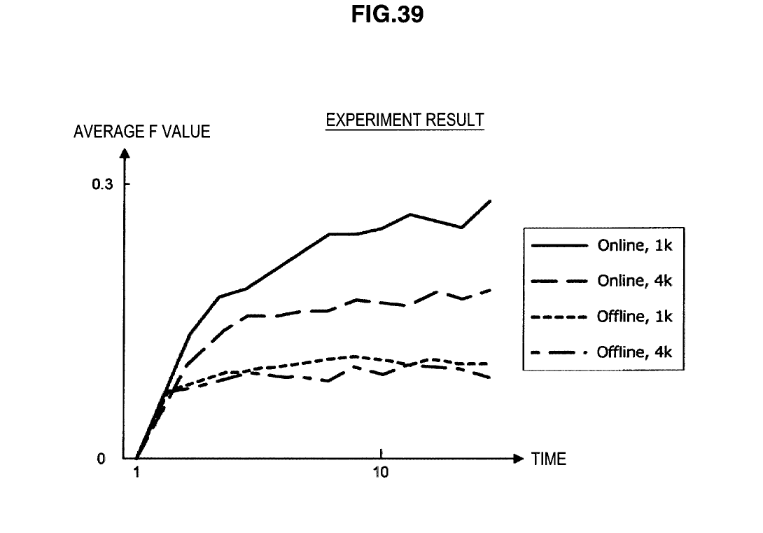

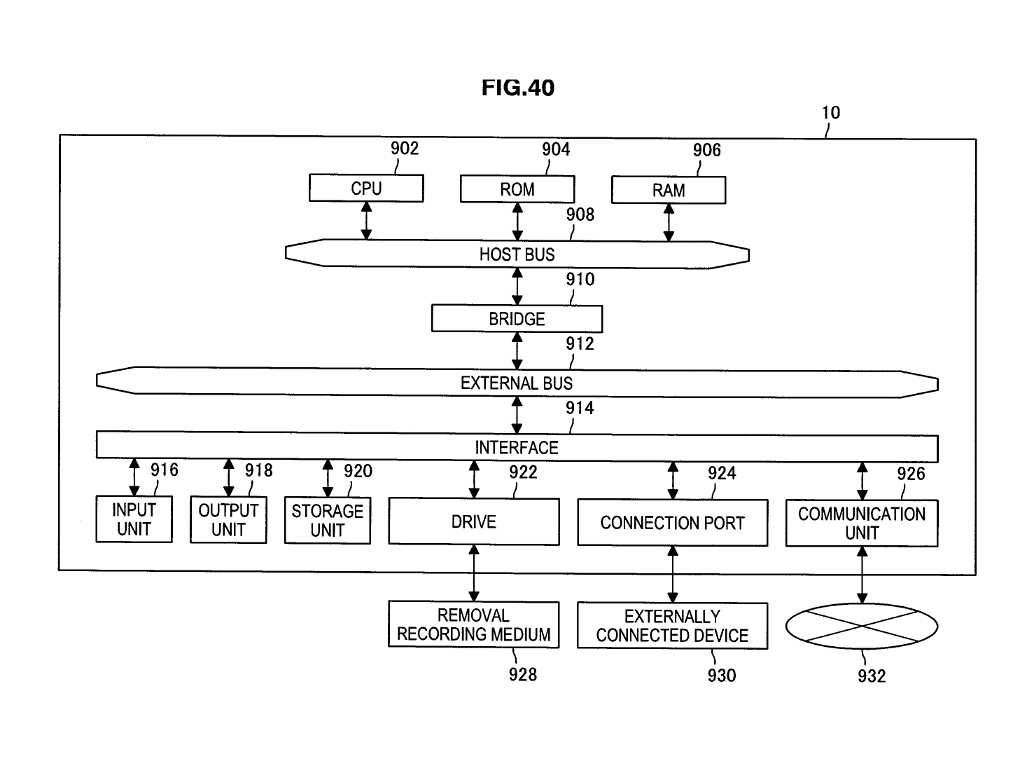

Subsequently, referring to FIG. 37, a description will be made on an application method of the technology according to the embodiment to an automatic construction method of an image recognizer. Subsequently, referring to FIG. 38, a description will be made on an application method of the technology according to the embodiment to an automatic construction method of a language analyzer. Subsequently, referring to FIG. 39, a description will be made on an effect of the online learning according to the embodiment. Subsequently, referring to FIG. 40, a description will be made on an example of a hardware configuration capable of achieving functions of the information processing device 10 according to the embodiment.

Finally, a description will be made on technical idea of the embodiment, and a brief description will be made on the working-effect obtained from the technical idea.

(Description Items)

1: Introduction

1-1: Automatic construction method of estimator

1-1-1: Configuration of estimator

1-1-2: Construction processing flow

1-2: For achieving online learning

2: Embodiment

2-1: Functional configuration of the information processing device 10

2-2: Learning data integration method 2-2-1: Distribution of learning data in a feature quantity space and accuracy of estimator

2-2-2: Configuration for sampling at data integration

2-2-3: Configuration for weighting at data integration

2-2-4: Configuration for sampling and weighting at data integration

2-3: Efficient sampling/weighting method

2-3-1: Sampling method

2-3-2: Weighting method

2-3-3: Combining method

2-4: Modification of sampling processing and weighting processing

2-4-1: Modification 1 (processing based on distance)

2-4-2: Modification 2 (processing based on clustering)

2-4-3: Modification 3 (processing based on density estimation technique)

3: Example of application

3-1: Automatic construction method of image recognizer

3-2: Automatic construction method of language analyzer

4: Example of hardware configuration

5: Summary

### Introduction

Embodiments describe below relates to an automatic construction method of an estimator. Also, the embodiments relates to a configuration to add learning data used for estimator construction (hereinafter, referred to as online learning). Before describing the technology according to the embodiment in detail, a description will be made on the problems to be solved to achieve the automatic construction method and the online learning of the estimator. In the following description, an example of automatic construction method of the estimator based on genetic algorithm will be given. However, applicable range of the technology according to the embodiment is not limited to the above.

[1-1: Automatic Construction Method of Estimator]

Automatic construction method of estimator will be described below.

(1-1-1: Configuration of Estimator)

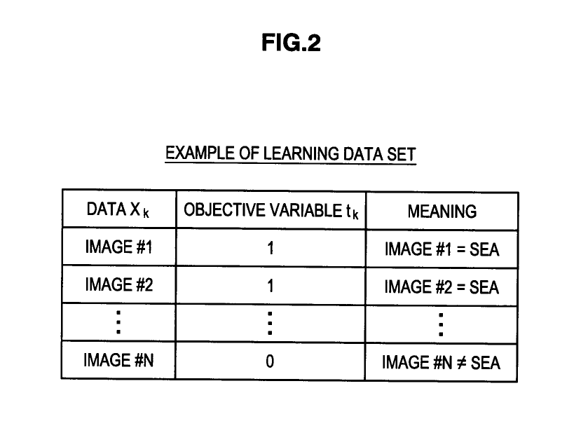

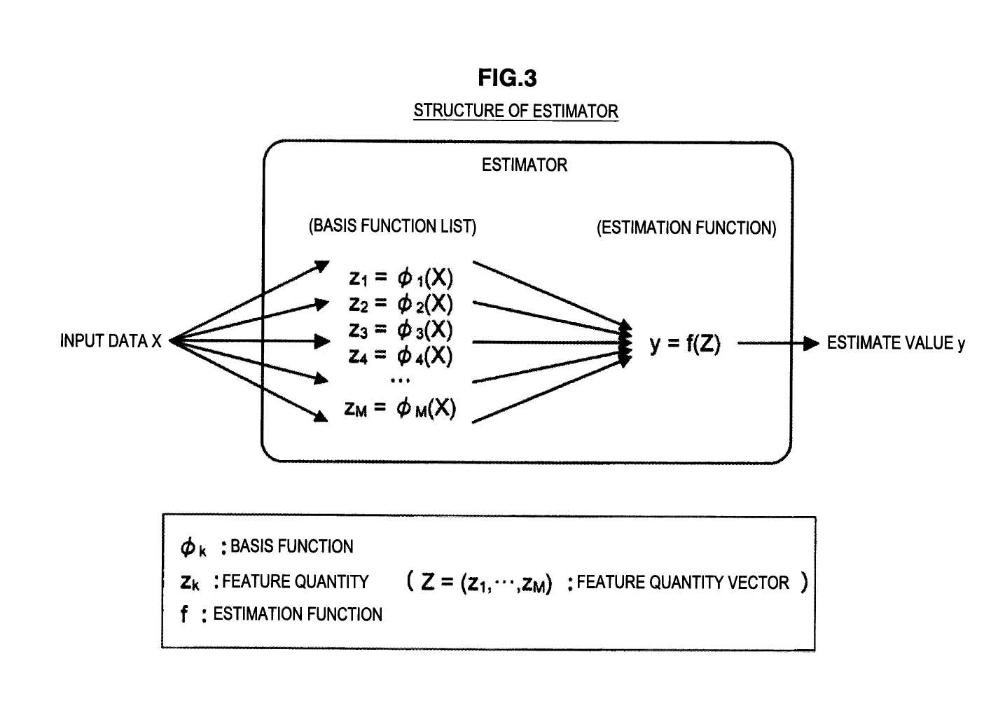

Referring to FIG. 1 through FIG. 3, a configuration of estimator will be described first. FIG. 1 is a diagram illustrating an example of a system configuration of a system which uses an estimator. FIG. 2 is a diagram showing an example of a configuration of learning data which is used for estimator construction. FIG. 3 is a diagram showing an outline of a structure and construction method of an estimator.

Referring to FIG. 1, construction of an estimator and calculation of estimate value are perfumed by the information processing device 10 for example. The information processing device 10 constructs the estimator using plural pieces of learning data (X₁, t₁), . . . , (X_{N}, t_{N}). In the following description, a set of learning data may be referred to as learning data set. Also, the information processing device 10 calculates an estimate value y from an input data X by using the constructed estimator. The estimate value y is used recognizing the input data X. For example, when the estimate value y is larger than a predetermined threshold value Th, a recognition result YES is output; and when the estimate value y is smaller than the predetermined threshold value Th, a recognition result NO is output.

Referring to FIG. 2, configuration of the estimator will be considered more particularly. A learning data set exemplified in FIG. 2 is used for construction of image recognizer for recognizing an image of “sea”. In this case, the estimator constructed by the information processing device 10 outputs an estimate value y representing “probability of sea” of an input image. The learning data is configured including a pair of data Xₖ and an objective variable tₖ (k=1 to N) as shown in FIG. 2. Data Xₖ indicates a k-th image data (image #k). The objective variable tₖ is a variable which results in 1 when the image #k is an image of “sea”; and results in 0 when the image #k is not an image of “sea”.

In the example in FIG. 2, the image #1 is an image of “sea”; the image #2 is an image of “sea”; . . . , the image #N is not an image of “sea”. In this case, the objective variables tₖ are t₁=1, t₂=1, . . . and t_{N}=0. When the learning data set is input, the information processing device 10 performs machine learning based on the input learning data set, and constructs an estimator which outputs an estimate value y representing “probability of sea” of the input image. The higher “probability of sea” of the input image, the estimate value y is closer to 1; and when the “probability of sea” is lower, the estimate value y is closer to 0.

When a new input data X (image X) is input, the information processing device 10 inputs the image X into the constructed estimator using the learning data set, and calculates the estimate value y representing the “probability of sea” of the image X. By using the estimate value y, it is possible to recognize whether the image X is an image of “sea”. For example, when the estimate value y≧(the predetermined threshold value Th), the input image X is recognized as an image of “sea”. On the other hand, when the estimate value y<(the predetermined threshold value Th), the input image X is recognized as an image of not “sea”.

The embodiment relates to a technology to automatically construct an estimator as described above. Note that an estimator which is used for constructing an image recognizer has been described above. However, the technology according to the embodiment may be applied to automatic construction method on various estimators. For example, the technology according to the embodiment may be applied to construction of a language analyzer, or to a music analyzer which analyzes melody line and/or code progression of music. Also, the technology according to the embodiment may be applied to a movement predictor which reproduces a natural phenomenon such as movement of a butterfly and/or a cloud.

The technology according to the embodiment may be applied to algorithms disclosed in, for example, JP-A-2009-48266, Japanese Patent Application No. 2010-159598, Japanese Patent Application No. 2010-159597, Japanese Patent Application No. 2009-277083, Japanese Patent Application No. 2009-277084 and the like. Also, the technology according to the embodiment may be applied to an ensemble learning method such as AdaBoost or a learning method such as SVM or SVR in which Kernel is used. When the technology according to the embodiment is applied to an ensemble learning method such as AdaBoost, a weak learner corresponds to a basis function φ which will be described below. Also, when the technology according to the embodiment is applied to a learning method such as SVM or SVR, Kernel corresponds to a basis function φ which will be described below. SVM is an abbreviation of support vector machine; and SVR is an abbreviation of support vector regression; and RVM is an abbreviation of relevance vector machine.

Referring to FIG. 3, a description is made on a structure of the estimator. The estimator is configured including a basis function list (φ₁, . . . , φ_{M}) and an estimation function f as shown in FIG. 3. The basis function list (φ₁, . . . , φ_{M}) includes M basis functions φₖ (k=1 to M). The basis function φₖ is a function which outputs a feature quantity zₖ responding to the input of the input data X. The estimation function f is a function which outputs an estimate value y responding to the input of a feature quantity vector Z=(z₁, . . . , zₘ) including M feature quantities zₖ (k=1 to M) as elements. The basis function φₖ is generated by combining one or plural processing functions, which are previously prepared.

As for the processing function, for example, a trigonometric function, an exponent function, four arithmetic operations, a digital filter, a differential operator, a median filter, a normalizing calculation, an additional processing of white noise, an image processing filter are available. For example, when the input data X is an image, basis function φⱼ(X)=AddWhiteNoise(Median(Blur(X))), in which an additional processing of white noise AddWhiteNoise( ) a median filter Median( ) blur processing Blur( ) or the like are combined, is used. The basis function φⱼ means that the blur processing, the median filter processing, and the additional processing of white noise is made in order on the input data X.

(1-1-2: Construction Processing Flow)

The configuration of the basis function φhd k(k=1 to M), the configuration of the basis function list and the configuration of the estimation function f is determined by the machine learning based on the learning data set. The construction processing of the estimator by the machine learning will be described in detail.

(Entire Configuration)

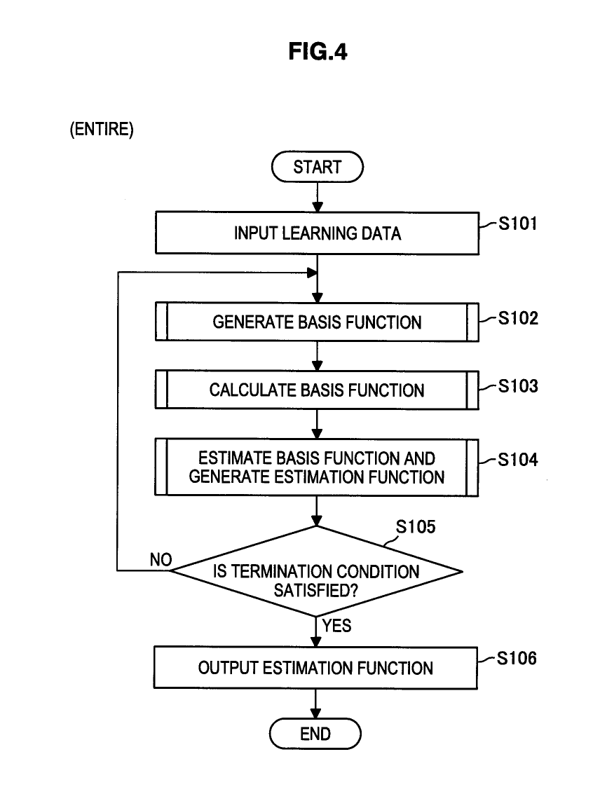

Referring to FIG. 4, a description is made on entire processing flow. FIG. 4 is a flowchart showing entire processing flow. The following processing is performed by the information processing device 10.

As shown in FIG. 4, a learning data set is input into the information processing device 10 first (S101). A pair of a data X and an objective variable t is input as the learning data. When the learning data set is input, the information processing device 10 combines processing functions to generate a basis function (S102). Subsequently, the information processing device 10 inputs the data X into the basis function and calculates the feature quantity vector Z (S103). Subsequently, the information processing device 10 estimates the basis function and generates an estimation function (S104).

Subsequently, the information processing device 10 determines whether a predetermined termination condition is satisfied (S105). When the predetermined termination condition is satisfied, the information processing device 10 forwards the processing to step S106. On the other hand, when the predetermined termination condition is not satisfied, the information processing device 10 returns the processing to step S102, and repeats the processing steps S102 to S104. When the processing proceeds to step S106, the information processing device 10 outputs the estimation function (S106). As described above, the processing steps S102 to S104 are repeated. In the following description, in a τ-th repeated processing, the basis function generated in step S102 will be referred to as τ-th generation basis function.

(Generation of Basis Function (S102))

Here, referring to FIG. 5 to FIG. 10, a detailed description is made on the processing (generation of basis function) in step S102.

Referring to FIG. 5, the information processing device 10 determines whether the present generation is the second generation or later (S111). That is, the information processing device 10 determines whether the processing in step S102, which is just to be performed, is the repeated processing from the second repetition or later. When the processing is the second generation or later, the information processing device 10 forwards the processing to step S113. On the other hand, when the processing is not the second generation or later (when the processing is the first generation), the information processing device 10 forwards the processing to step S112. When the processing proceeds to step S112, the information processing device 10 randomly generates a basis function (S112). On the other hand, when the processing proceeds to step S113, the information processing device 10 evolutionary generates a basis function (S113). When the processing in step S112 or S113 is completed, the information processing device 10 terminates the processing in step S102.

(S112: Random Generation of Basis Function)

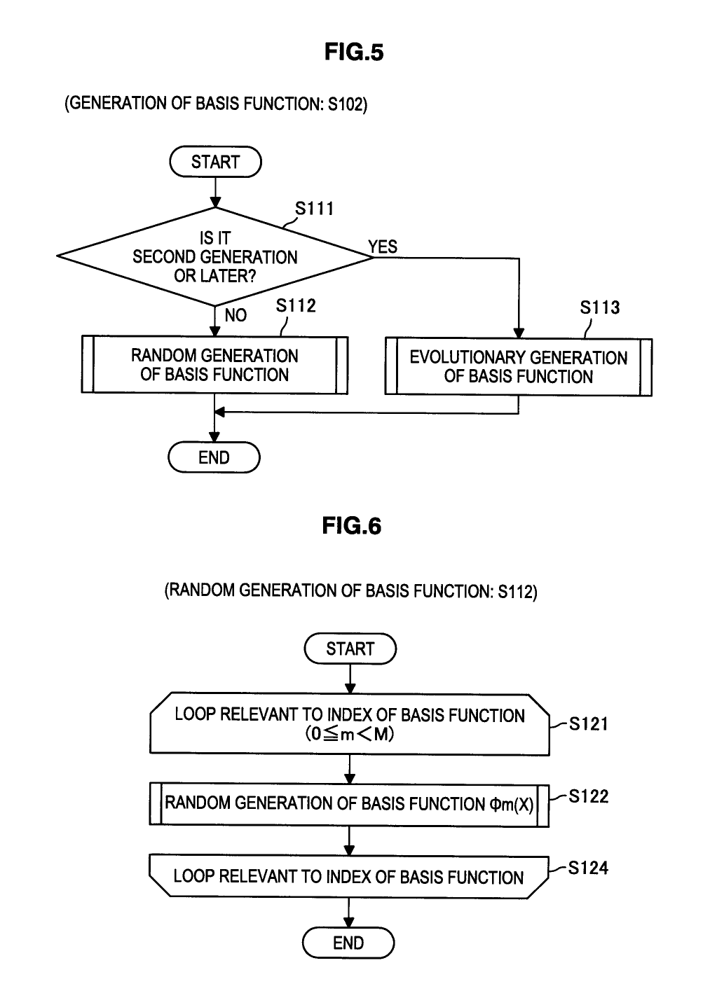

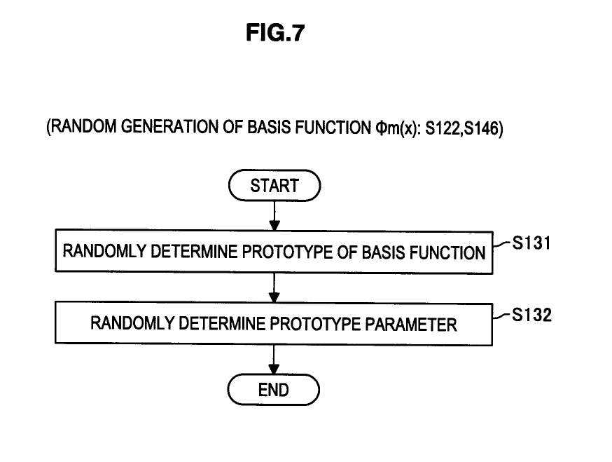

Referring to FIG. 6 and FIG. 7, a more detailed description is made on the processing in step S112. The processing in step S112 relates to the processing of generation of the first basis function.

Referring to FIG. 6, the information processing device 10 starts a processing loop relevant to an index m (m=0 to M−1) of the basis function (S121). Subsequently, the information processing device 10 randomly generates a basis function φₘ(x) (S122). Subsequently, the information processing device 10 determines whether the index m of the basis function has reached M−1. When the index m of the basis function has not reached M−1, the information processing device 10 increments the index m of the basis function, and returns the processing to step S121 (S124). On the other hand, when the index m of the basis function is m=M−1, the information processing device 10 terminates the processing loop (S124). When the processing loop is terminated in step S124, the information processing device 10 completes the processing in step S112.

(Detailed Description of Step S122)

Referring to FIG. 7, detailed description is made on the processing in step S122.

When the processing is started in S122, the information processing device 10 randomly determines a prototype of the basis function as shown in FIG. 7 (S131). As for the prototype, in addition to the processing functions which have been described above, processing functions such as linear term, a Gaussian Kernel and a sigmoid kernel are available. Subsequently, the information processing device 10 randomly determines a parameter of the determined prototype, and generates a basis function (S132).

(S113: Evolutionary Generation of Basis Function)

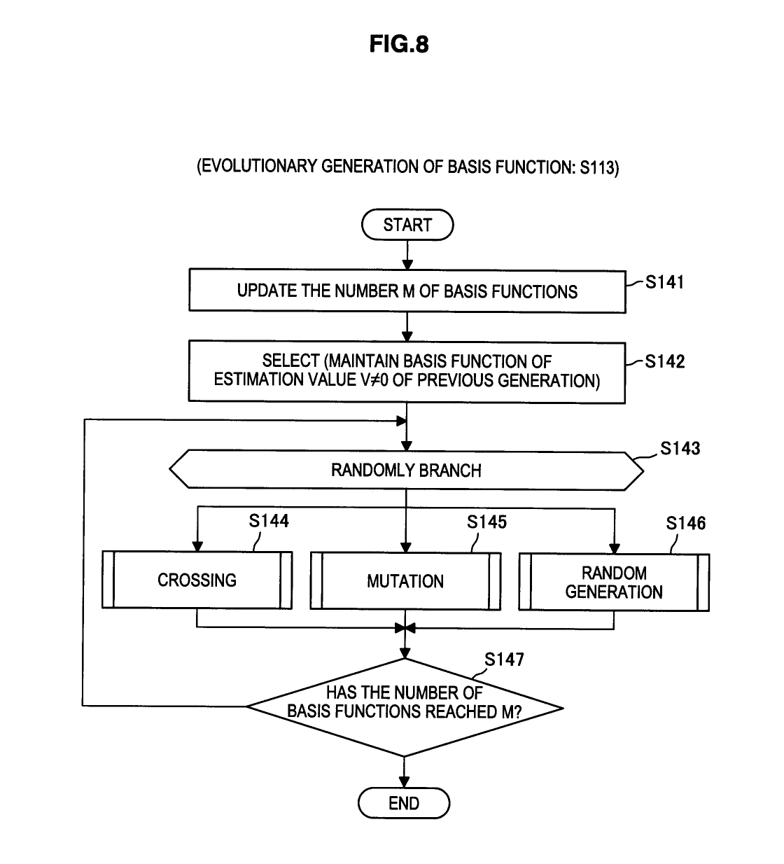

Referring to FIG. 8 to FIG. 10, more detailed description is made on the processing in step S113. The processing in step S113 relates to the processing to generate a τ-th generation (τ≧2 or larger) basis function. Before performing the processing in step S113, a basis function φ_{m, τ-1} (m=1 to M) of the (τ−1)—the generation and an evaluation value v_{m, τ-1} of the basis function φ_{m, τ-1} have been obtained.

Referring to FIG. 8, the information processing device 10 updates the number M of the basis function (S141). That is, the information processing device 10 determines the number M_{τ} of the τth generation basis function. Subsequently, the information processing device 10 selects e useful basis functions from the (τ−19)—the generation basis functions based on the evaluation value v_{τ-1}={v_{1, τ-1}, . . . , v_{M, τ-1}} with respect to the (τ−1)—the generation basis function φ_{m, τ-1} (m=1 to M), and sets the same to the τ-th generation basis function φ_{1, τ}, . . . , φ_{e, τ} (S142).

Subsequently, the information processing device 10 randomly selects a method to generate the rest (M_{τ}−e) basis functions φ_{e+1, τ}, . . . , φ_{Mτ, τ} from crossing, mutation, random generation (S143). When the crossing is selected, the information processing device 10 forwards the processing to step S144. When the mutation is selected, the information processing device 10 forwards the processing to step S145. When the random generation is selected, the information processing device 10 forwards the processing to step S146.

When the processing is proceeded to step S144, the information processing device 10 crosses the basis function from the selected basis functions φ_{1, τ}, . . . . , φ_{e, τ} which are selected in step S142, and generates a new basis function φ_{m′, τ} (m′≧e+1) (S144). When the processing is proceeded to step S145, the information processing device 10 mutates the basis function from the selected basis functions φ_{1, τ}, . . . , φ_{e, τ} which are selected in step S142, and generates a new basis function φ_{m′, τ} (m′≧e+1) (S145). On the other hand, when the processing is proceeded to step S146, the information processing device 10 randomly generates a new basis function φ_{m′, τ} (m′≧e+1) (S146).

When completing the processing any of the steps S144, S145 and S146, the information processing device 10 forwards the processing to step S147. After forwarding the processing to step S147, the information processing device 10 determines whether the τ-th generation basis function has reached M (M=M_{τ}) (S147). When the τ-th generation basis function has not reached M, the information processing device 10 returns the processing to step S143 again. On the other hand, when the τ-th generation basis function has reached M, the information processing device 10 terminates the processing in step S113.

(Detailed Description of S144: Crossing)

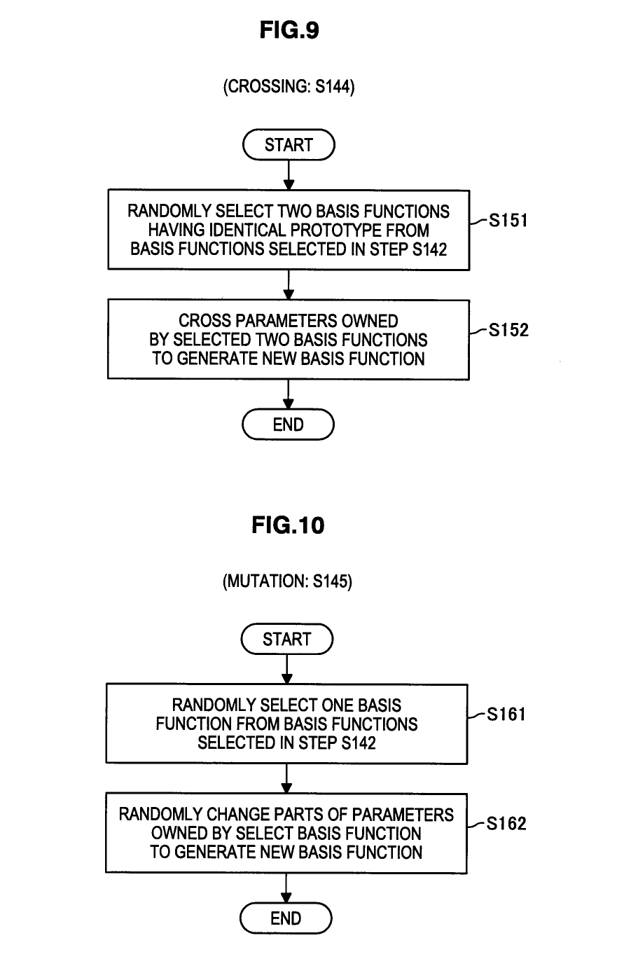

Referring to FIG. 9, a detailed description is made on the processing in step S144.

After starting the processing in step S144, the information processing device 10 randomly selects two basis functions which have identical prototype from the basis functions φ_{1, τ}, . . . , φ_{e, τ} which are selected in step S142 as shown in FIG. 9 (S151). Subsequently, the information processing device 10 crosses the parameters owned by the selected two basis functions to generate a new basis function (S152).

(Detailed Description of S145: Mutation)

Referring to FIG. 10, a detailed description is made on the processing in step S145.

After starting the processing in step S145, the information processing device 10 randomly selects a basis function from the basis functions φ_{1, τ}, . . . , φ_{e, τ} which are selected in step S142 as shown in FIG. 10 (S161) as shown in FIG. 10. Subsequently, the information processing device 10 randomly changes a part of parameters owned by the select basis function to generate a new basis function (S162).

(Detailed Description of S146: Random Generation)

Referring to FIG. 7, a detailed description is made on the processing in step S146.

After starting the processing in step S122, the information processing device 10 randomly determines a prototype of the basis function (S131). As for the prototype, in addition to processing functions which have been described above, processing functions such as linear term, Gaussian Kernel, sigmoid kernel and the like are available. Subsequently, the information processing device 10 randomly determines parameters of the determined prototype to generate a basis function (S132).

A detailed description has been made on the processing (generation of basis function) in step S102.

(Calculation of Basis Function (S103))

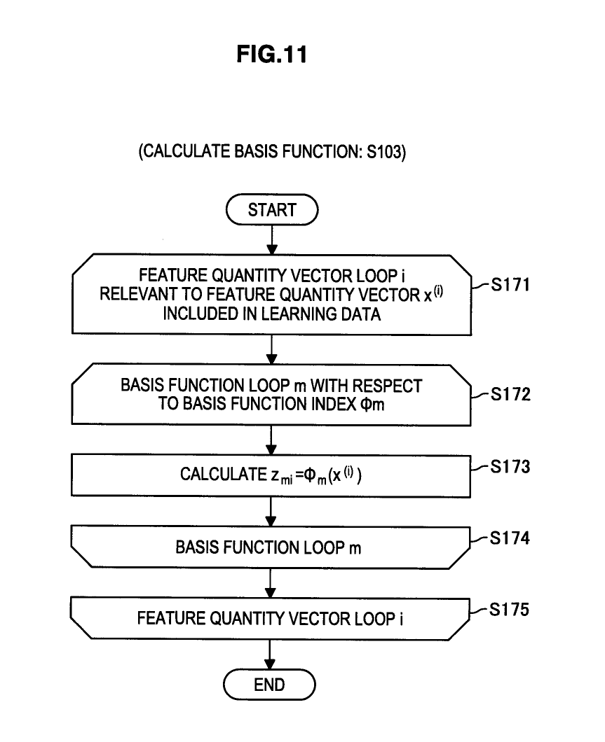

Subsequently, referring to FIG. 11, a detailed description is made on the processing (calculation of basis function) in step S103.

The information processing device 10 starts a processing loop relevant to an index i of an i-th data X⁽ⁱ⁾ which is included in a learning data set as shown in FIG. 11 (S171). For example, when N data pairs {X⁽¹⁾, . . . , X^{(N)}} are input as a learning data set, a processing loop is executed with respect to i=1 to N. Subsequently, the information processing device 10 starts a processing loop with respect to an index m of a basis function φₘ (S172). For example, when M basis functions are generated, a processing loop is executed with respect to m=1 to M.

Subsequently, the information processing device 10 calculates feature quantity zₘᵢφₘ(x⁽ⁱ⁾) (S173). Subsequently, the information processing device 10 forwards the processing to step S174, and continues the processing loop with respect to the index m of the basis function. When the processing loop with respect to the index m of the basis function terminates, the information processing device 10 forwards the processing to step S175 and continues the processing loop with respect to the index i. When the processing loop with respect to the index i terminates, the information processing device 10 terminates the processing in step S103.

A detailed description has made on the processing (calculation of basis function) in step S103.

(Generation of Evaluation/Estimation Function of Basis Function (S104))

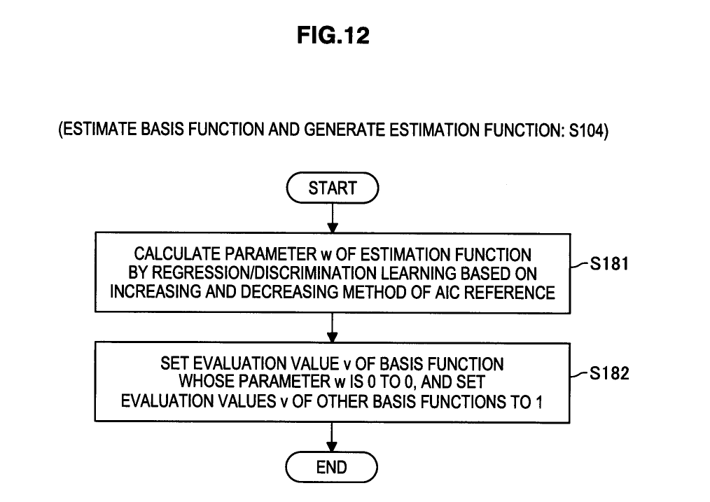

Referring to FIG. 12, a detailed description is made on the processing (generation of evaluation/estimation function of basis function) in step S104.

The information processing device 10 calculates a parameter w={w₀, . . . , w_{M}} of an estimation function by regression/discrimination learning based on increasing and decreasing method of an AIC reference as shown in FIG. 12 (S181). That is, the information processing device 10 calculates a vector w={w₀, . . . , w_{M}} by regression/discrimination learning so that the feature quantity zₘᵢ=φ_{m, τ}(x⁽ⁱ⁾) and the objective variable t⁽ⁱ⁾ pair (i=1 to N) are fitted to each other by an estimation function f. Wherein, the estimation function f(x) is f(x)=Σw_{mφm, τ}(x)+w₀. Subsequently, the information processing device 10 sets an evaluation value v of the basis function whose parameter w is 0, and sets evaluation values v of other basis functions to 1 (S182). That is, the basis function, the evaluation value v of which is 1, is a useful basis function.

A detailed description has been made on the processing (generation of evaluation/estimation function of basis function) in step S104 has been made.

The processing flow relevant to the estimator construction is as described above. Thus, the processing from steps S102 through S104 is repeated, and the basis function is updated sequentially by the evolutional technique to thereby the estimation function with a high estimation accuracy is obtained. That is, by applying the above-described method, a high performance estimator is automatically constructed.

[1-2: For Achieving Online Learning]

In the case of an algorithm which automatically constructs the estimator through the machine learning, the larger number of the learning data results in the higher performance of the constructed estimator. Therefore, it is preferable to construct the estimator by using as many pieces of learning data as possible. However, the memory capacity of the information processing device 10 which is used for storing the learning data is limited. Also, when the number of the learning data is large, a higher calculation performance is necessary for achieving estimator construction. In such reason, as long as the above-described method (hereinafter, referred to as offline learning) is used, in which the estimator is constructed through batch processing, the performance of the estimator is limited by the resources held by the information processing device 10.

The inventors of the present technology have worked out a configuration (hereinafter, referred to as online learning) capable of sequentially adding the learning data. The estimator construction through the online learning is performed along a processing flow shown in FIG. 13. First, a learning data set is input into the information processing device 10 as shown in FIG. 13 (Step 1). Subsequently, the information processing device 10 uses the input learning data set to construct the estimator through automatic construction method of the estimator described above (Step 2).

Subsequently, the information processing device 10 obtains added learning data sequentially or at a predetermined timing (Step 3). Subsequently, the information processing device 10 integrates the learning data set input in (Step 1) and the learning data obtained in (Step 3) (Step 4). At this time, the information processing device 10 performs sampling processing and/or weighting processing of the learning data to generate an integrated learning data set. The information processing device 10 uses the integrated learning data set, and constructs a new estimator (Step 2). At this time, the information processing device 10 constructs the estimator using the automatic construction method of estimator described above.

The estimator constructed in (Step 2) may be output every time of construction. The processing from (Step 2) through (Step 4) is repeated. The learning data set is updated every time when the processing is repeated. For example, when the learning data is added at every repetition of the processing, the number of learning data which is used for construction processing of the estimator increases, thereby the performance of the estimator is enhanced. However, since the resources of the information processing device 10 has a limitation, in the integration processing of the learning data executed in (Step 4), it is necessary to elaborate the integration manner so that more useful learning data is used for estimator construction.

(Summing Up of Problems)

As shown in FIG. 14, when applying the offline learning, since the number of learning data used for construction processing of the estimator is limited, there is a limitation for further improving the performance of the estimator. On the other hand, by applying the online learning, since the learning data can be added, it is expected that the performance of the estimator can be further improved. However, since the resources of the information processing device 10 has a limitation, in order to further improve the performance of the estimator within the limited resources, it is necessary to elaborate the integration method of the learning data. The following technology according to the embodiment has been worked out to solve the above problems.

### 2: Embodiments

An embodiment of the present technology will be described below.

[2-1: Functional configuration of the information processing device 10]

Referring to FIG. 15 and FIG. 16, a description is made on the functional configuration of the information processing device 10 according to the present embodiment. FIG. 15 is a diagram showing entire functional configuration of the information processing device 10 according to the present embodiment. On the other hand, FIG. 16 is a diagram showing entire functional configuration of an estimator construction section 12 according to the present embodiment.

(Entire Functional Configuration)

Referring to FIG. 15, a description is made on entire functional configuration. As shown in FIG. 15, the information processing device 10 is configured including mainly a learning data obtaining section 11, the estimator construction section 12, an input data obtaining section 13 and a result recognition section 14.

When the construction processing of the estimator starts, the learning data obtaining section 11 obtains a learning data used for estimator construction. For example, the learning data obtaining section 11 reads a learning data which is store in a storage (not shown). Or, the learning data obtaining section 11 obtains a learning data from a system which provides the learning data via a network. Also, the learning data obtaining section 11 may obtain a data attached with a tag, and generate the learning data including a pair of the data and an objective variable based on the tag.

The set of learning data (learning data set), which is obtained by the learning data obtaining section 11, is input into the estimator construction section 12. When the learning data set is input, the estimator construction section 12 constructs the estimator through machine learning based on the input learning data set. For example, the estimator construction section 12 constructs the estimator by using the automatic construction method of the estimator based on the above-described genetic algorithm. When an added learning data is input from the learning data obtaining section 11, the estimator construction section 12 integrates the learning data and constructs the estimator by using the integrated learning data set.

The estimator constructed by the estimator construction section 12 is input into the result recognition section 14. The estimator is used for obtaining a recognition result with respect to arbitrary input data. When the input data as a recognition object is obtained by the input data obtaining section 13, the obtained input data is input into the result recognition section 14. When the input data is input, the result recognition section 14 inputs the input data into the estimator, and generates a recognition result based on an estimate value output from the estimator. For example, as shown in FIG. 1, the result recognition section 14 compares an estimate value y and a predetermined threshold value Th, and outputs the recognition result in accordance with the comparison result.

A description has made above on the entire functional configuration of the information processing device 10.

(Functional Configuration of the Estimator Construction Section 12)

Referring to FIG. 16, a detailed description is made on the functional configuration of the estimator construction section 12. As shown in FIG. 16, the estimator construction section 12 is configured including a basis function list generating section 121, a feature quantity calculation section 122, an estimation function generation section 123 and a learning data integration section 124.

When the construction processing of the estimator starts, the basis function list generating section 121 generates a basis function list. The basis function list generated by the basis function list generating section 121 is input to the feature quantity calculation section 122. Also, the learning data set is input into the feature quantity calculation section 122. When the basis function list and the learning data set are input, the feature quantity calculation section 122 inputs the data included in the input learning data set into the basis function included in the basis function list to calculate the feature quantity. The pair of the feature quantity (feature quantity vector) calculated by the feature quantity calculation section 122 is input into the estimation function generation section 123.

When the feature quantity vector is input, the estimation function generation section 123 generates an estimation function through the regression/discrimination learning based on an objective variable which configures the input feature quantity vector and the learning data. When applying the construction method of the estimator based on the genetic algorithm, the estimation function generation section 123 calculates the contribution ratio (evaluation value) of each basis function with respect to the generated estimation function to determine whether the termination conditions are satisfied based on the contribution ratio. When the termination conditions are satisfied, the estimation function generation section 123 outputs the estimator which includes the basis function list and the estimation function.

On the other hand, when the termination conditions are not satisfied, the estimation function generation section 123 notifies the contribution ratio of the respective basis functions with respect to the generated estimation function to the basis function list generating section 121. Receiving the notification, the basis function list generating section 121 updates the basis function list based on the contribution ratio of the respective basis functions through the genetic algorithm. When the basis function list is updated, the basis function list generating section 121 inputs the updated basis function list to the feature quantity calculation section 122. When the updated basis function list is input, the feature quantity calculation section 122 calculates the feature quantity vector using updated basis function list. The feature quantity vector calculated by the feature quantity calculation section 122 is input into the estimation function generation section 123.

As described above, when applying the construction method of estimator based on the genetic algorithm generating processing of the estimation function by the estimation function generation section 123, the update processing of the basis function list by the basis function list generating section 121 and the calculating processing of the feature quantity vector by the feature quantity calculation section 122 are repeated until the termination conditions are satisfied. When the termination conditions are satisfied, the estimator is output from the estimation function generation section 123.

When the added learning data is input, the input added learning data is input into the feature quantity calculation section 122 and the learning data integration section 124. When the added learning data is input, the feature quantity calculation section 122 inputs the data which configures the added learning data into the respective basis functions included in the basis function list to generate a feature quantity. The feature quantity vector corresponding to the added learning data and the feature quantity vector corresponding to the existing learning data are input into the learning data integration section 124. The existing learning data are also input into the learning data integration section 124.

The learning data integration section 124 integrates the existing learning data set and the added learning data based on the learning data integration method, which will be describe below. For example, the learning data integration section 124 thins out the learning data, and/or sets a weight to the learning data so that the distribution of the coordinates indicated by the feature quantity vectors in the feature quantity space (hereinafter, referred to as feature quantity coordinate) results in the predetermined distribution. When the learning data is thinned out, the thinned learning data set is used as the integrated learning data set. On the other hand, when a weight is set to the learning data, the weight which is set to each of the learning data is taken into consideration through the regression/discrimination learning by the estimation function generation section 123.

When the learning data are integrated, the automatic construction processing of the estimator is executed by using the integrated learning data set. In particular, the integrated learning data set and the feature quantity vector corresponding to the learning data included in the integrated learning data set are input into the estimation function generation section 123 from the learning data integration section 124, and the estimation function generation section 123 generates an estimation function. Also, when applying the construction method of estimator based on the genetic algorithm, the processing such as generation of the estimation function, calculation of the contribution ratio and update of the basis function list is executed by using the integrated learning data set.

The detailed description has been made on the functional configuration of the estimator construction section 12.

[2-2: Learning Data Integration Method]

Subsequently, a description is made on the learning data integration method according to the embodiment. The learning data integration method described here is achieved by the function of the learning data integration section 124.

(2-2-1: Distribution of Learning Data in Feature Quantity Space and Accuracy of the Estimator)

Referring to FIG. 17, a consideration is given on the relationship between the distribution of learning data in a feature quantity space and the accuracy of the estimator. FIG. 17 is a diagram illustrating an example of the distribution of learning data in the feature quantity space.

A feature quantity vector is obtained by inputting data which configures a learning data into each of the basis functions included in the basis function list. That is, the learning data corresponds to one feature quantity vector (feature quantity coordinates). Therefore, the distribution in the feature quantity coordinates is referred here to as distribution of learning data in the feature quantity space. The distribution of learning data in the feature quantity space is, for example, as shown in FIG. 17. For the purpose of explanation, in the example shown in FIG. 17, an example of a two dimensional feature quantity space is given. However, the number of the dimension of the feature quantity space is not limited to the above.

Referring to the distribution of the feature quantity coordinates in the example shown in FIG. 17, there is a sparse area in the fourth quadrant. As described above, the estimation function is generated through the regression/discrimination learning on every learning data so that the relationship between the feature quantity vector and the objective variable is satisfactorily expressed. Therefore, with respect to the sparse area where the density of the feature quantity coordinates is sparse, there is a high possibility that the estimation function may not represent satisfactorily the relationship between the feature quantity vector and the objective variable. Therefore, when the feature quantity coordinates corresponding to an input data as an object of the recognition processing is located in the sparse area, it is hardly expected to obtain a high accuracy recognition result.

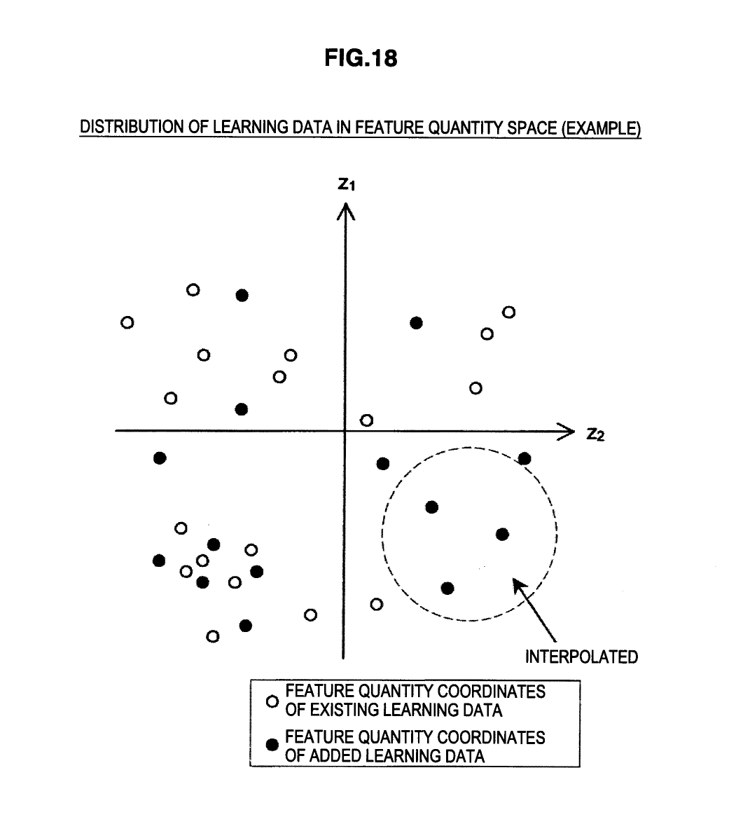

As shown in FIG. 18, when the number of the learning data increases, the sparse area is eliminated, and even when any area, that corresponds to the input data, may be input, it is expected to obtain an estimator which is capable of outputting recognition result at a high accuracy. Also, even when the number of the learning data is relatively small, when the feature quantity coordinates are distributed uniformly in the feature quantity space, it is expected that an estimator which is capable of outputting recognition result at a high accuracy can be obtained. Under such circumstances, the inventors of the technology have worked out such a configuration in which, when integrating learning data, the distribution of the feature quantity coordinates is taking into consideration so that, the distribution of the feature quantity coordinates corresponding to the integrated learning data set has a predetermined distribution (for example, uniform distribution, Gauss distribution or the like).

(2-2-2: Configuration of Sampling at Data Integration)

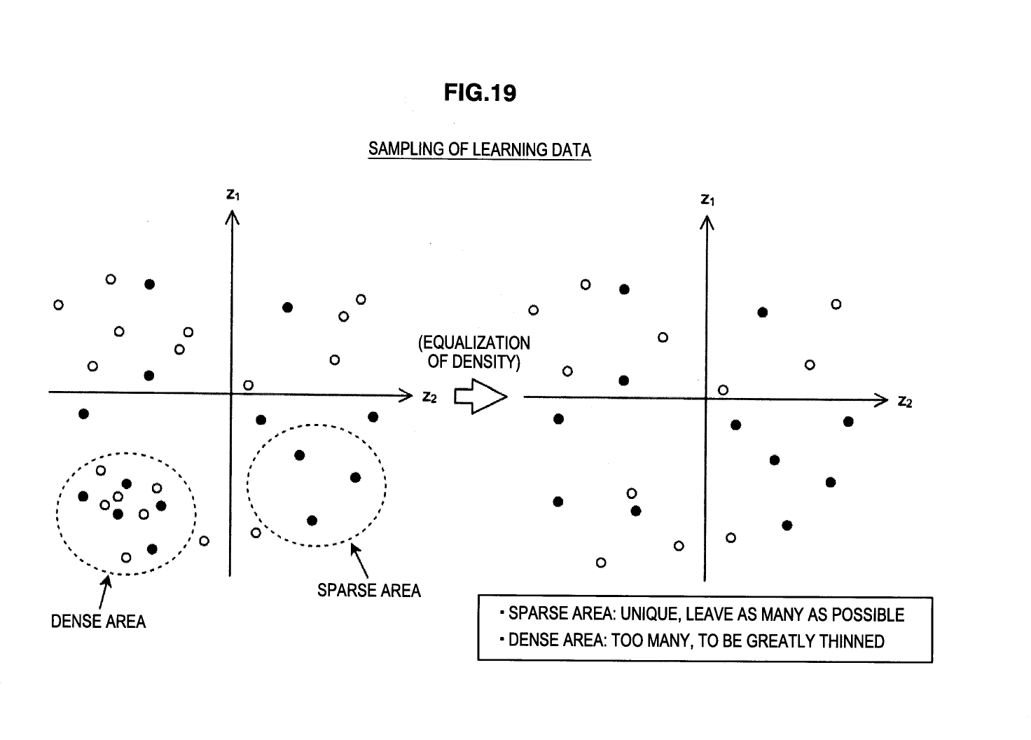

Referring to FIG. 19, a description is made on the method of sampling learning data. FIG. 19 is a diagram illustrating a method of sampling learning data.

As described above, when applying the online learning, since the learning data can be added sequentially, the estimator can be constructed by using a large quantity of learning data. However, when the memory resource of the information processing device 10 has a limitation, it is necessary to reduce the number of the learning data used for estimator construction when integrating the learning data. At this time, the learning data is not randomly thinned, but by thinning the learning data while taking considering the distribution in the feature quantity coordinates, the number of the learning data can be reduced without detonating the accuracy of the estimator. For example, as shown in FIG. 19, in a dense area, many feature quantity coordinates are thinned; while in a sparse area, the feature quantity coordinates are left as many as possible.

By thinning out the learning data using the above-described method, the density of the feature quantity coordinates corresponding to the integrated learning data set is equalized. That is, although the number of the learning data is reduced, since the feature quantity coordinates are distributed uniformly in the entire feature quantity space, when executing the regression/discrimination learning to generate an estimation function, the entire of the feature quantity space is taken into consideration. As a result, even when the memory resource of the information processing device 10 is limited, it is possible to construct an estimator capable of estimating a recognition result at a high accuracy.

(2-2-3: Configuration of Weighting at Data Integration)

Subsequently, a description is made on a method to set a weight to the learning data.

When the memory resource of the information processing device 10 is limited, the method, in which learning data is thinned when integrating the learning data, is effective. On the other hand, when the memory resource has enough capacity, in place of thinning the learning data, the performance of the estimator can be enhanced by setting a weight to the learning data. For example, the learning data which includes feature quantity coordinates in a sparse area, a larger weight is set; while the learning data which includes feature quantity coordinates in a dense area, a smaller weight is set. When executing the regression/discrimination learning to generate an estimation function, the weight, which is set to each learning data, is taken into consideration.

(2-2-4: Configuration of Sampling and Weighting at Data Integration)

The method of sampling the learning data and the method of setting a weight to the learning data may be combined. For example, after thinning the learning data to obtain a predetermined distribution of the feature quantity coordinates, a weight corresponding to the density of the feature quantity coordinates is set to the learning data included in the thinned learning data set. Thus, by combining the thinning processing and the weighting processing, an estimator with a higher accuracy can be obtained even when the memory resource has a limitation.

[2-3: Efficient Sampling/Weighting Method]

Subsequently, a description is made on an efficient sampling/weighting method of the learning data.

(2-3-1: Sampling Method)

Referring to FIG. 20, a description is made on an efficient sampling method of learning data. FIG. 20 is a diagram showing an efficient sampling method of learning data.

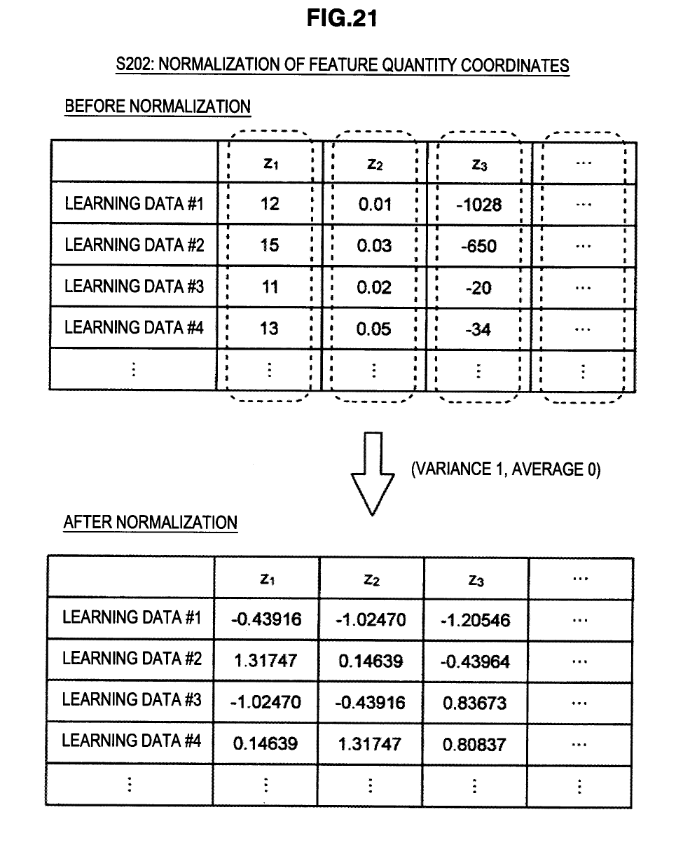

As shown in FIG. 20, the information processing device 10 calculates the feature quantity vector (feature quantity coordinates) on every learning data by using the function of the feature quantity calculation section 122 (S201). Subsequently, the information processing device 10 normalizes the calculated feature quantity coordinates by the function of the feature quantity calculation section 122 (S202). For example, the feature quantity calculation section 122 normalizes the values on each feature quantity so that variance is 1; and average is 0 as shown in FIG. 21. The feature quantity coordinates, which have been thus normalized, are input into the learning data integration section 124.

Subsequently, the information processing device 10 randomly generates a hash function “g” by using the function of the learning data integration section 124 (S203). For example, the learning data integration section 124 generates a plurality of hash functions “g” which outputs a 5-bit value shown in a formula (1) below. At this time, the learning data integration section 124 generates Q hash functions g_{q} (q=1 to Q). Wherein, a function h, (j=1 to 5) is defined by a formula (2) below. Also, “d” and Threshold are determined by a random number.

When making the distribution in the feature quantity coordinates be closer to a uniform distribution, a uniform random number is used as a random number used for determining the Threshold. When making the distribution in the feature quantity coordinates to be closer to a Gauss distribution, a Gauss random number is used as a random number used for determining the Threshold. The other distributions are identical to the above. “d” is determined by using a random number which is a bias corresponding to the contribution ratio of the basis function which is used for calculating z_{d}. For example, for a larger contribution ratio of the basis function which is used for calculating z_{d}, a random number, which has a higher probability to generate d, is used.

$$\begin{matrix}g ( Z ) = \{ {h}_{1} ( Z ) , {h}_{2} ( Z ) , {h}_{3} ( Z ) , {h}_{4} ( Z ) , {h}_{5} ( Z ) \} & ( 1 ) \\ {h}_{j} ( Z ) = \{ \begin{matrix}1 & ( {z}_{d} > Threshold ) \\ 0 & ( {z}_{d} \leq Threshold )\end{matrix} & ( 2 )\end{matrix}$$

After generating the hash functions g_{q} (q=1 to Q), the learning data integration section 124 inputs a feature quantity vector Z corresponding to the respective learning data into the hash functions g_{q} to calculate hash values. The learning data integration section 124 allots the learning data to buckets based on the calculated hash value (S204). The wording “bucket” here means an area associated with values which are possible as hash values.

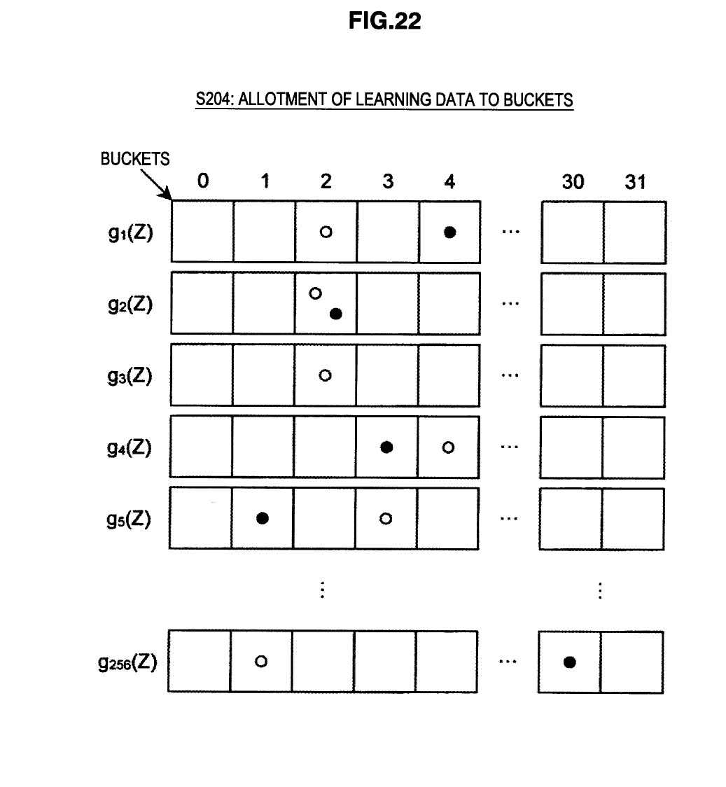

For example, it is assumed a case of a hash values of 5-bit and Q=256. In this case, the configuration of the bucket is as shown in FIG. 22. As shown in FIG. 22, since the hash value is 5-bit, 32 buckets (hereinafter, referred to as bucket set) are allotted to one hash function g_{q}. Also, since Q=256, 256 bucket sets are allotted. Taking this case as an example, a description will be made on a method allotting the learning data to the buckets.

When a feature quantity vector Z corresponding to a learning data is given, 256 hash values are calculated by using 256 hash functions g₁ to g₂₅₆. For example, when g₁ (Z)=2 (indicated by a decimal number), the learning data integration section 124 allots the learning data to buckets corresponding to 2 in the bucket set corresponding to g₁. Likewise, g_{q}(Z) (q=2 to 256) is calculated, and learning data are allotted to the buckets corresponding to the respective values. In the example shown in FIG. 22, two different kinds of learning data are represented with white and black circles, and correspondence relationship with the respective buckets is schematically represented.

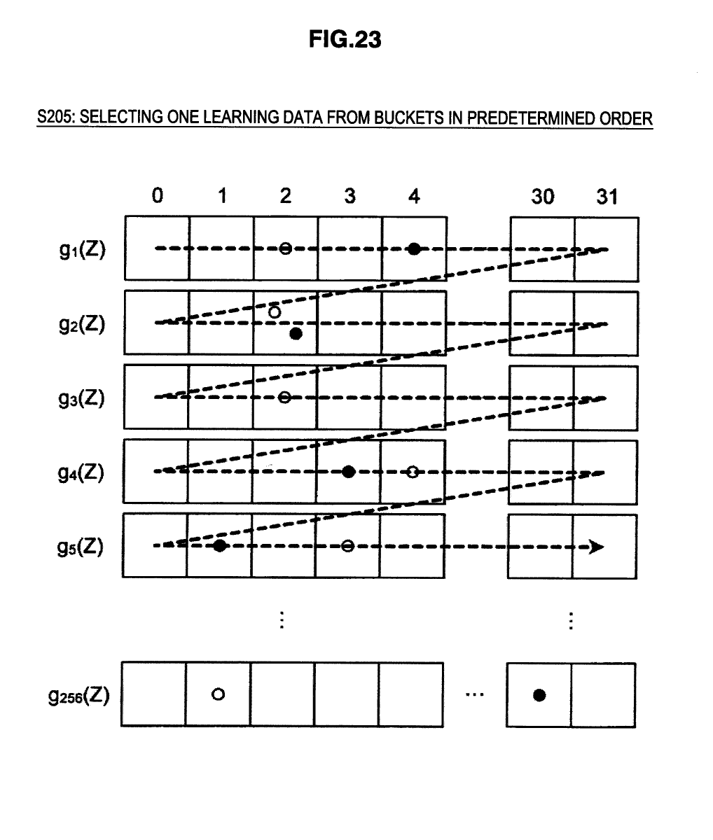

After allotting the learning data to the buckets, the learning data integration section 124 selects one learning data from the buckets in a predetermined order (S205). For example, the learning data integration section 124 scans the buckets from the left top (index q of hash function is smaller, and the value allotted to the buckets is smaller) as shown in FIG. 23 and selects one learning data allotted to the buckets.

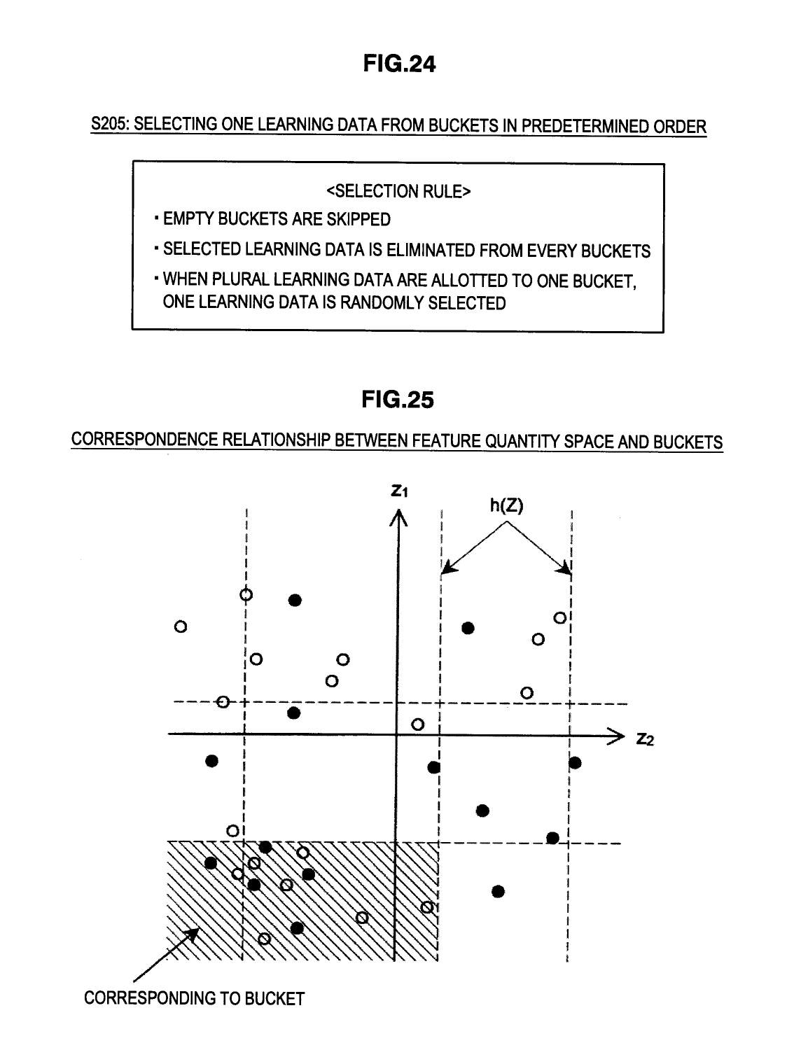

The rule to select the learning data from the buckets is as shown in FIG. 24. First, the learning data integration section 124 skips void buckets. Second, when one learning data is selected, the learning data integration section 124 eliminates identical learning data from the other buckets. Third, when plural learning data are allotted to one bucket, the learning data integration section 124 randomly selects one learning data. The information of the selected learning data is held by the learning data integration section 124.

After selecting one learning data, the learning data integration section 124 determines whether a predetermined number of the learning data has been selected (S206). When the predetermined number of the learning data has been selected, the learning data integration section 124 outputs the selected predetermined number of the learning data as an integrated learning data set; and terminates a series of processing relevant to integration of the learning data. On the other hand, when the predetermined number of the learning data has not been selected, the learning data integration section 124 forwards the processing to step S205.

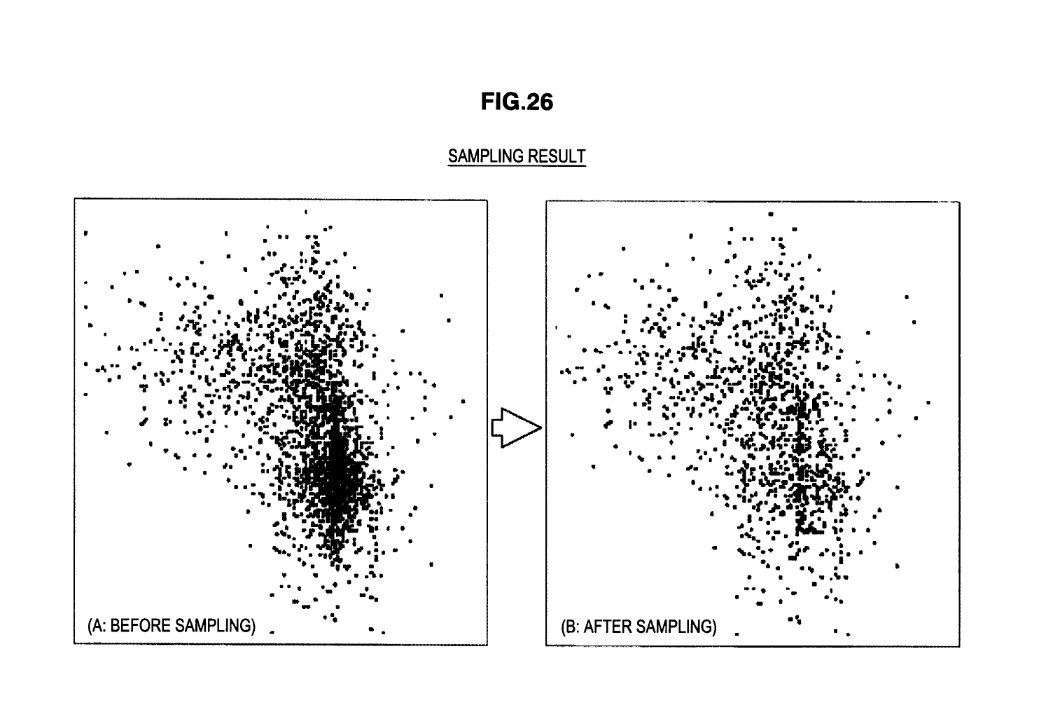

The efficient sampling method of the learning data has been described above. The correspondence relationship between the feature quantity space and the buckets is shown in an imaginary illustration in FIG. 25. The sampling result of the learning data by using the above method is, for example, shown in FIG. 26 (example of uniform distribution). Referring to FIG. 26, it is demonstrated that the feature quantity coordinates included in a sparse area are left as they are; and the feature quantity coordinates included in a dense area are thinned. It should be noted that when the above-described buckets are not be used, a considerably large calculation load is imposed to the learning data integration section 124 for sampling of the learning data.

(2-3-2: Weighting Method)

Referring to FIG. 27 a description is made below on an efficient weighting method of the learning data. FIG. 27 is a diagram showing an efficient weighting method of the learning data.

As shown in FIG. 27, the information processing device 10 calculates the feature quantity vector (feature quantity coordinates) on every learning data by using the function of the feature quantity calculation section 122 (S211). Subsequently, the information processing device 10 normalizes the calculated feature quantity coordinates by the function of the feature quantity calculation section 122 (S212). For example, the feature quantity calculation section 122 normalizes the values on each feature quantity so that variance is 1; and average is 0 as shown in FIG. 21. The feature quantity coordinates, which have been thus normalized, are input into the learning data integration section 124.

Subsequently, the information processing device 10 randomly generates a hash function “g” by using the function of the learning data integration section 124 (S213). For example, the learning data integration section 124 generates a plurality of hash functions “g” which outputs a 5-bit value shown in a formula (1) below. At this time, the learning data integration section 124 generates Q hash functions g_{q} (q=1 to Q). Wherein, a function hⱼ (j=1 to 5) is defined by a formula (2) above. Also, “d” and Threshold are determined by a random number.

When making the distribution in the feature quantity coordinates to be closer to a uniform distribution, a uniform random number is used as a random number used for determining the Threshold. When making the distribution in the feature quantity coordinates to be closer to a Gauss distribution, a Gauss random number is used as a random number used for determining the Threshold. The other distributions are identical to the above. “d” is determined by using a random number which is a bias corresponding to the contribution ratio of the basis function which is used for calculating z_{d}. For example, for a larger contribution ratio of the basis function which is used for calculating z_{d}, a random number, which has a higher probability to generate d, is used.

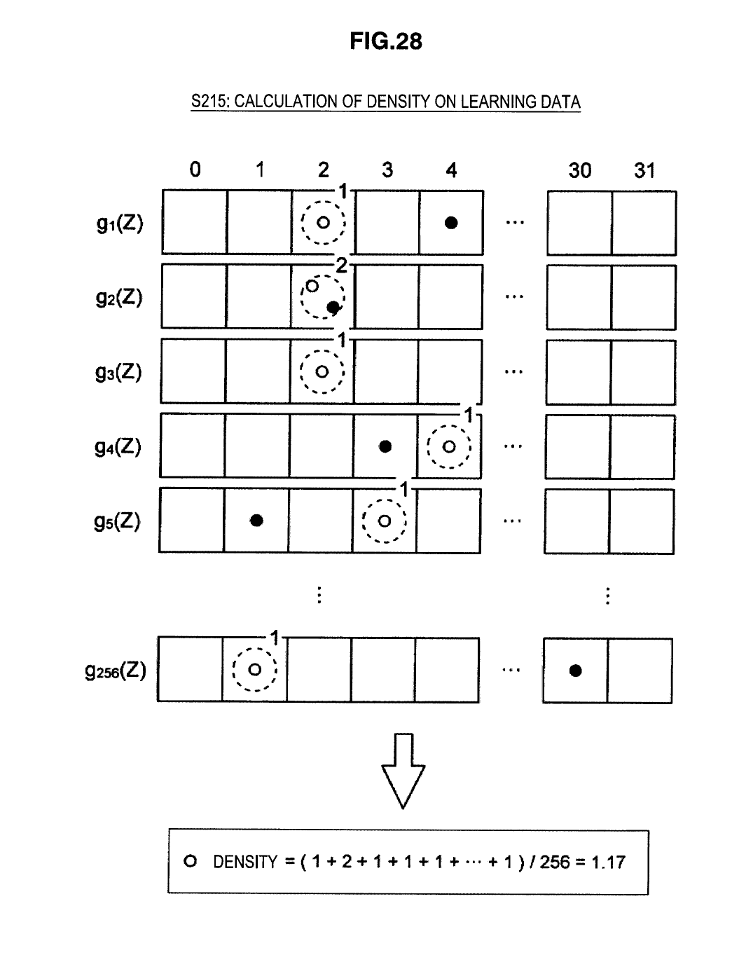

After generating the hash functions g_{q} (q=1 to Q), the learning data integration section 124 inputs a feature quantity vector Z corresponding to the respective learning data into the hash functions g_{q} to calculate hash values. The learning data integration section 124 allots the learning data to buckets based on the calculated hash value (S214). Subsequently, the learning data integration section 124 calculates the density on each learning data (S215). It is assumed that the learning data are allotted to the buckets as shown in FIG. 28, for example. The learning data represented with a white circle are focused here.

In this case, the learning data integration section 124 counts the number of the learning data allotted to the buckets which includes white circles with respect to the bucket sets corresponding to the hash functions. Referring to the bucket set corresponding to the hash function g₁, for example, the number of the learning data is 1, which is allotted to the bucket including white circle. Likewise, referring to the bucket set corresponding to the hash function g₂, the number of the learning data is 2, which is allotted to the bucket including white circle. The learning data integration section 124 counts the number of the learning data allotted to the bucket including the white circle with respect to the bucket set corresponding to the hash functions g₁ to g₂₅₆.

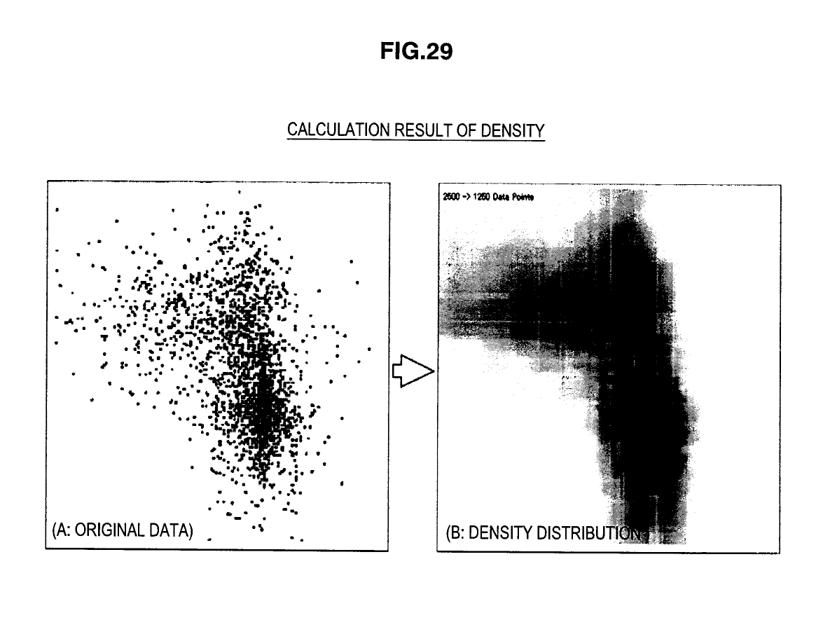

The learning data integration section 124 calculates an average value of the counted number and assumes the calculated average value as the density of the learning data corresponding to the white circles. Likewise the learning data integration section 124 calculates the density of every learning data. The density of the respective learning data is expressed as shown in FIG. 29B. The density in an area with dense color is higher; and the density in an area with thin color is lower.

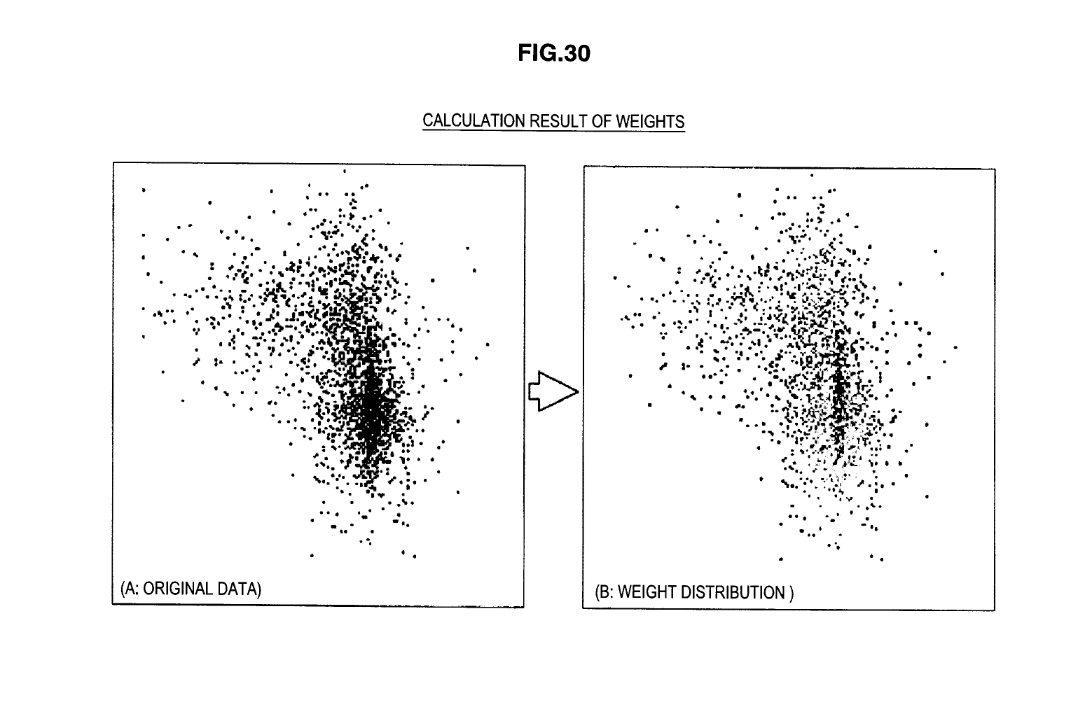

After calculating the density on every learning data, the learning data integration section 124 forwards the processing to step S217 (S216). When the processing proceeds to step S217, the learning data integration section 124 calculates a weight to be set to each learning data from the calculated density (S217). For example, the learning data integration section 124 sets an inverse number of the density as the weight. The distribution of the weights which are set on each learning data are expressed as shown in FIG. 30B. The density in an area with dense color is higher; and the density in an area with thin color is lower. Referring to FIG. 30, it is demonstrated that the weight in the dense area is small; and the weight in the sparse area is large.

After thus calculating the weight to be set to each learning data, the learning data integration section 124 terminates a series of the weighting processing. The efficient weighting method of the learning data has been described above. It should be noted that if the above-described buckets are not used, the calculation load necessary for weighting the learning data becomes considerably large.

(2-3-3: Combining Method)

Referring to FIG. 31, a description is made on a combining method of the above-described efficient sampling method and the efficient weighting method. FIG. 31 is a flowchart showing a combining method of the above-described efficient sampling method and the efficient weighting method.

The learning data integration section 124 executes sampling processing of the learning data as shown in FIG. 31 (S221). The sampling processing is executed along the processing flow shown in FIG. 20. When a predetermined number of learning data is obtained, the learning data integration section 124 executes the weighting processing on the obtained learning data (S222). The weighting processing is executed along the processing flow shown in FIG. 27. The feature quantity vector and/or hash function which are calculated during sampling processing may be utilized. After executing the sampling processing and the weighting processing, the learning data integration section 124 terminates the series of the processing.

The efficient sampling/weighting method of the learning data has been described above. The description has been made on the efficient sampling/weighting method to efficiently make the distribution of the feature quantity coordinates closer to a predetermined distribution. However, the application range of the sampling/weighting method of the data utilizing the buckets is not limited to the above. For example, with respect to arbitrary data group, after allotting the data to the buckets based on the hash function, by sampling the data from the buckets in accordance with the rule shown in FIG. 24; thereby the distribution of the group of arbitrary data can be efficiently made closer to a predetermined distribution. This is the same as for the weighting processing.

[2-4: Modifications with Respect to Sampling Processing and Weighting Processing]

Subsequently, a description is made below on modifications with respect to the sampling processing and the weighting processing.

(2-4-1: Modification 1 (Processing Based on Distance))

Referring to FIG. 32, a description is made below on the sampling method of the learning data based on the distance between feature quantity coordinates. FIG. 32 is a flowchart illustrating sampling method of the learning data based on the distance between feature quantity coordinates.

The learning data integration section 124 randomly selects one feature quantity coordinate as shown in FIG. 32 (S231). The learning data integration section 124 initializes the index j to 1 (S232). Subsequently, the learning data integration section 124 sets a j-th feature quantity coordinate as the target coordinates from J feature quantity coordinates which are not selected yet (S233). The learning data integration section 124 calculates a distance D between the every feature quantity coordinates, which are already selected, and the target coordinates (S234). Subsequently, the learning data integration section 124 extracts a maximum value Dₘᵢₙ of the calculated distance D (S235).

Subsequently, the learning data integration section 124 determines whether j=J (S236). When kJ, the learning data integration section 124 forwards the processing to step S237. On the other hand, when j≠1, the learning data integration section 124 forwards the processing to step S233. When the processing proceeds to step S237, the learning data integration section 124 selects the target coordinates (feature quantity coordinates) in which the maximum value Dₘᵢₙ of which is the largest (S237). Subsequently, the learning data integration section 124 determines whether the number of feature quantity coordinates selected in step S231 and S237 has reached to a predetermined number (S238),

When, the number of the feature quantity coordinates has reached to the predetermined number in selected step S231 and S237, the learning data integration section 124 outputs the learning data corresponding to the selected feature quantity coordinates as the integrated learning data set; and terminates the series of processing. On the other hand, the number of the feature quantity coordinates has not reached to the predetermined number in selected step S231 and S237, the learning data integration section 124 forwards the processing to step S232.

The sampling method of learning data based on the distance between feature quantity coordinates has been described above.

(2-4-2: Modification 2 (Processing Based on Clustering))

Subsequently, a description is made below on a sampling/weighting method of the learning data based on the clustering. In the following description, although the sampling method and the weighting method will be described separately, these methods may be combined with each other.

(Selection of Learning Data)

Referring to FIG. 33, a description is made below on a sampling/weighting method of the learning data based on the clustering. FIG. 33 is a flowchart illustrating the sampling method of the learning data based on the clustering.

The learning data integration section 124 sorts the feature quantity vectors into a predetermined number of clusters as shown in FIG. 33 (S241). As for the clustering technique, for example, k-means method, hierarchical clustering and the like are available. Subsequently, the learning data integration section 124 selects feature quantity vectors one by one in order from the respective clusters (S242). The learning data integration section 124 outputs a pair of learning data corresponding to the selected feature quantity vector as an integrated learning data set; and terminates the series of processing.

(Setting of Weight)

Referring to FIG. 34, a description is made below on the weighting method of learning data based on the clustering. FIG. 34 is a flowchart illustrating the weighting method of learning data based on the clustering.

The learning data integration section 124 sorts the feature quantity vectors into a predetermined number of clusters as shown in FIG. 34 (S251). As for the clustering technique, for example, k-means method, hierarchical clustering and the like are available. Subsequently, the learning data integration section 124 counts the number of elements of the respective clusters and calculates an inverse number of the number of elements (S252). The learning data integration section 124 outputs the inverse number of the calculated number of the elements as the weight; and terminates the series of the processing.

The sampling/weighting method of the learning data based on the clustering has been described above.

(2-4-3: Modification 3 (Processing Based on the Density Estimation Technique))

A description is made below on a sampling/weighting method of the learning data based on the density estimation technique. In the following description, although the sampling method and the weighting method will be described separately, these methods may be combined with each other.

(Selection of Learning Data)

Referring to FIG. 35, a description is made below on the sampling method of the learning data based on the density estimation technique. FIG. 35 is a flowchart illustrating the sampling method of the learning data based on the density estimation technique.

The learning data integration section 124 modelizes the density of the feature quantity coordinates as shown in FIG. 35 (S261). For modelizing the density, for example, the density estimation technique such as GMM (Gaussian mixture model) is available. The learning data integration section 124 calculates the density of the respective feature quantity coordinates based on the constructed model (S262). The learning data integration section 124 randomly selects feature quantity coordinates at a probability proportional to the inverse number of the density from the feature quantity coordinates which are not selected yet (S263).

Subsequently, the learning data integration section 124 determines whether a predetermined number of feature quantity coordinates has been selected (S264). When the predetermined number feature quantity coordinates has not been selected, the learning data integration section 124 forwards the processing to step S263. On the other hand, when the predetermined number feature quantity coordinates has been selected, the learning data integration section 124 outputs a pair of the learning data corresponding to the selected feature quantity coordinates as an integrated learning data set; and terminates the series of the processing.

(Weight Setting)

Referring to FIG. 36, a description is made below on the weighting method of the learning data based on the density estimation technique. FIG. 36 is a flowchart illustrating the weighting method of the learning data based on the density estimation technique.

The learning data integration section 124 modelizes the density of the feature quantity coordinates as shown in FIG. 36 (S271). For modelizing the density, for example, a density estimation technique such as GMM is used. Subsequently, the learning data integration section 124 calculates the density of the respective feature quantity coordinates based on the constructed model (S272). The learning data integration section 124 sets the inverse number of the calculated density as the weight; and terminates the series of the processing.

The sampling/weighting method of the learning data based on the density estimation technique has been described above.

### 3: Example of Application

A description is made below on examples of application of the technology according to the embodiment. The technology according to the embodiment is applicable to a wide range. The technology according to the embodiment is applied to automatic construction for various discriminators and analyzers such as discriminator of image data, discriminator of text data, discriminator of voice data, discriminator of signal data and the like. A description is made below on applications to an automatic construction method of an image recognizer and an automatic construction method of a language analyzer as examples of application.

[3-1: Automatic Construction Method of Image Recognizer]

Referring to FIG. 37, a description is made below on the application to an automatic construction method of an image recognizer. FIG. 37 is a diagram illustrating a generating method of a learning data set used for construction of the image recognizer. The wording “image recognizer” here means an algorithm which, when an image is input, automatic recognizes whether the image is an image of “flower”, an image of “sky” or an image of “sushi”, for example.

In the above description, it is assumed that a learning data, which is configured including a data “X” and an objective variable “t”, is given. However, when online learning is intended, the learning data set is preferably generated automatically from, for example, information obtained by crawling on the Web services (hereinafter, referred to as obtained information). For example, it is assumed that a piece of information shown in FIG. 37A is obtained. The obtained information is configured including an image and a tag given to the image. When constructing an image recognizer which recognizes whether the input image is an image of “flower” for example, the information processing device 10 allots an objective variable t=1 to an image the tag of which includes “flower”; and allots an objective variable t=0 to the images other than the “flower” (refer to table B in FIG. 37).

Likewise, when constructing an image recognizer which recognizes whether the input image is an image of “sky”, the information processing device 10 allots an objective variable t=1 to an image the tag of which includes “sky”; and allots an objective variable t=0 to the images other than the above (refer to table C in FIG. 37). Also, when constructing an image recognizer which recognizes whether the input image is an image of “sushi”, the information processing device 10 allots an objective variable t=1 to an image the tag of which includes “sushi”; and allots an objective variable t=0 to the images other than the above (refer to table D in FIG. 37). By using tags as described above, a learning data set, which can be used for constructing a desired image recognizer, is generated.

When the learning data set is generated, the estimator (calculation means for the estimate value “y”) which is used by the image recognizer (means for obtaining a recognition result from the estimate value “y”) can be automatically constructed by executing the integration processing of the learning data and the construction processing of the estimator, which has been described above. The application to the automatic construction method of the image recognizer has been described.

[3-2: Automatic Construction Method of Language Analyzer]

Referring to FIG. 38, a description is made on an application to the automatic construction method of the language analyzer. FIG. 38 is a diagram illustrating a generating method of a learning data set used for constructing the language analyzer. The wording “language analyzer” here means an algorithm which, when a text is input, automatically recognizes whether the text relevant to, for example, “politics”, “economy” or “entertainment”.

In the above description, it is assumed that a learning data, which is configured including a data “X” and an objective variable “t”, is given. However, when online learning is intended, the learning data set is preferably generated automatically from, for example, information obtained by crawling on the Web services (obtained information). For example, it is assumed that a piece of information shown in FIG. 38A is obtained. The obtained information is configured including a text and a tag given to the text. When constructing a language analyzer which recognizes whether an input text is a text relevant to “politics” for example, the information processing device 10 allots an objective variable t=1 to the text the tag of which relevant to “politics”; and allots an objective variable t=0 to the texts other than the “politics” (refer to table B in FIG. 38).

Likewise, when constructing a language analyzer which recognizes whether an input text is a text relevant to “economy”, the information processing device 10 allots an objective variable t=1 to a text the tag of which relevant to “economy”; and allots an objective variable t=0 to the texts other than the above (refer to table C in FIG. 38). Thus, by using tags, a learning data set which is used for constructing a desired language analyzer can be generated. When a learning data set is generated, by executing the above-described integration processing of the learning data and the construction processing of the estimator, an estimator (calculation means for the estimate value “y”) which is used for the language analyzer (means for obtaining a recognition result from the estimate value “y”) can be automatically constructed.

(Effect of Online Learning)

Experiments were made by using the above-described automatic construction method of language analyzer. The results of the experiments are shown in FIG. 39. In a graph shown in FIG. 39, the horizontal axis indicates elapse time (unit: day); and the vertical axis indicates average F value (average F-measures). The solid line (Online, 1 k) and the broken lines (Online, 4 k) represents the results of the experiments with the learning data sets which were continuously updated sequentially by online learning. On the other hand, the chain line (Offline, 1 k) and the dashed-dotted line (Offline, 4 k) represent results of the experiments by offline learning. 1 k indicates that the number of learning data used for estimator construction was set to 1000. On the other hand, 4 k indicates that the number of learning data used for estimator construction was set to 4000.

As demonstrated in FIG. 39, the larger number of the learning data used for the estimator construction results in the higher accuracy of the estimator. In the case of the offline learning, the accuracy stops soon to increasing. Contrarily, in the case of the online learning, the accuracy increases as the time passes. After a certain period of time has passed, the results of online learning are significantly superior to those of offline learning. From the experience results above, it is clear that high accuracy of the estimator can be achieved by updating the learning data set by online learning. Although the experience results of the automatic construction method of language analyzer are shown here, it is expected that like effects can be obtained by the automatic construction method for other recognizer.

(Summary of Effects)

As described above, by enabling the online learning, the accuracy of the estimator is enhanced. As for the technique of estimator construction, various methods are available such as algorithms described in, for example, JP-A 2009-48266; description of Japanese Patent Application No. 2010-159598; description of Japanese Patent Application No. 2010-159597; description of Japanese Patent Application No. 2009-277083; description of Japanese Patent Application No. 2009-277084 and the like. Therefore, in various kinds of recognizers, the accuracy can be enhanced. By providing a configuration to automatically generate a learning data set by using the information obtained from Web services etc, the accuracy of the estimator can be continuously enhanced with maintenance free. Also, by sequentially updating the learning data set, since the estimator is constantly constructed using new learning data set, the estimator can flexibly correspond to use of new tags or changes in meaning of tags accompanying the progress of technology.

### 4: Example of Hardware Configuration

The functions of each of the component elements included in the above-described information processing device 10 can be achieved by using, for example, a hardware configuration shown in FIG. 40. That is, the functions of the respective component elements can be achieved by controlling the hardware shown in FIG. 40 using a computer program. Any configuration of the hardware may be employed; i.e., mobile information terminals such as mobile phone, PHS, PDA, game machines or various information home electronics including, for example, personal computers. The above PHS is an abbreviation of personal handy-phone system; and the above PDA is an abbreviation of personal digital assistant.

As shown in FIG. 40, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls entire operation or a part of the operation of each structural element based on various programs recorded on the ROM 904, the RAM 906, the storage unit 920, or a removal recording medium 928. The ROM 904 is means for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removal recording medium 928 such as a magnetic disk, an optical disk, a magneto-optical disk or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an electronic device or an IC card on which a non-contact IC chip is mounted. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device for connecting to a network 932, and is, for example, a communication card for a wired or wireless LAN, Bluetooth (registered trademark), or WUSB, an optical communication router, an ADSL router, or various communication modems. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

Heretofore, an example of the hardware configuration has been described.

### 5: Wrapping-Up

Finally, a brief wrap-up is made on the technical idea of the embodiment. The following technical idea is applicable to various information processing devices including, for example, PCs, mobile phones, game machines, information terminals, information home electronics, car navigation systems and the like.

The functional configuration of the above-described information processing device may be expressed as below. For example, the following information processing device (1) adjusts the distribution of the feature quantity coordinates so that the distribution of the feature quantity coordinates in a feature quantity space becomes closer to a predetermined distribution. In particular, as described below (2), the information processing device thins out the learning data so that the distribution of the feature quantity coordinates in a feature quantity space becomes closer to a predetermined distribution. And as described below (3), a processing to weight the respective learning data is made. Needless to say, as described below (4), the thinning processing and the weighting processing may be combined with each other. By make the distribution of the feature quantity coordinates in the feature quantity space be closer to a predetermined distribution (for example, uniform distribution or Gauss distribution) by applying the above methods, the performance of the estimator can be enhanced.

(1)

An information processing device including:

a feature quantity vector calculation section that, when a plurality of pieces of learning data each configured including input data and an objective variable corresponding to the input data are given, inputs the input data into a plurality of basis functions to calculate feature quantity vectors which include output values from the respective basis functions as elements;

a distribution adjustment section that adjusts a distribution of points which are specified by the feature quantity vectors in a feature quantity space so that the distribution of the points becomes closer to a predetermined distribution; and

a function generation section that generates an estimation function which outputs an estimate value of the objective variable in accordance with input of the feature quantity vectors with respect to the plurality of pieces of learning data.

(2)

The information processing device according to (1), wherein the distribution adjustment section thins the learning data so that the distribution of the points which are specified by the feature quantity vectors in the feature quantity space becomes closer to the predetermined distribution.

(3)

The information processing device according to (1), wherein the distribution adjustment section weights each piece of the learning data so that the distribution of the points which are specified by the feature quantity vectors in the feature quantity space becomes closer to the predetermined distribution.

(4)

The information processing device according to (1), wherein the distribution adjustment section thins the learning data and weights each piece of the learning data remaining after thinning so that the distribution of the points which are specified by the feature quantity vectors in the feature quantity space becomes closer to the predetermined distribution.

(5)

The information processing device according to any of (1) to (4), wherein the predetermined distribution is a uniform distribution or a Gauss distribution.

(6)

The information processing device according to (2) or (4), wherein, when new learning data is additionally given, the distribution adjustment section thins a learning data group including the new learning data and the existing learning data so that the distribution of the points which are specified by the feature quantity vectors in the feature quantity space becomes closer to the predetermined distribution.

(7)

The information processing device according to any of (1) to (6), further including:

a basis function generation section that generates the basis function by combining a plurality of previously prepared functions.

(8)

The information processing device according to (7), wherein

the basis function generation section updates the basis function based on a genetic algorithm,

when the basis function is updated, the feature quantity vector calculation section inputs the input data into the updated basis function to calculate a feature quantity vector, and

the function generation section generates an estimation function which outputs an estimate value of the objective variable in accordance with input of the feature quantity vector which is calculated using the updated basis function.

(9)

An estimator generating method including:

inputting, when a plurality of pieces of learning data each configured including input data and objective variables corresponding to the input data are given, the input data into a plurality of basis functions to calculate feature quantity vectors which include output values from the respective basis functions as elements;

adjusting a distribution of points which are specified by the feature quantity vectors in a feature quantity space so that the distribution of the points becomes closer to a predetermined distribution; and

generating an estimation function which outputs estimate values of the objective variables in accordance with input of the feature quantity vectors with respect to the plurality of pieces of learning data.

(10)

A program for causing a computer to realize:

a feature quantity vector calculation function that, when a plurality of pieces of learning data each configured including input data and an objective variable corresponding to the input data are given, inputs the input data into a plurality of basis functions to calculate feature quantity vectors which include output values from the respective basis functions as elements;

a distribution adjustment function that adjusts a distribution of points which are specified by the feature quantity vectors in a feature quantity space so that the distribution of the points becomes closer to a predetermined distribution; and

a function generation function that generates an estimation function which outputs an estimate value of the objective variable in accordance with input of the feature quantity vectors with respect to the plurality of pieces of learning data.

(Note)

The above-described feature quantity calculation section 122 is an example of the feature quantity vector calculation section. The above-described learning data integration section 124 is an example of the distribution adjustment section. The above-described estimation function generation section 123 is an example of the function generation section. The above-described the basis function list generating section 121 is an example of the basis function generation section.

(1)

An information processing device including:

a data storage section having M area groups including 2^{N} storage areas;

a calculation section that performs processing M times to obtain a piece of N-bit output data Q by inputting a piece of input data to a second function which includes N first functions randomly-outputting 0 or 1 and outputs a value output from a k-th (k=1 to N) first function as a k-th bit value;

a storing processing section that, when a piece of output data Q is obtained by the calculation section at m-th (m=1 to M) time, stores the input data in a Q-th storage area in an m-th area group; and

a data obtaining section that obtains input data stored in the storage area one after another until a predetermined number of input data is obtained, by scanning the storage area in a predetermined order,

wherein, when a piece of input data identical to the obtained input data is stored in another storage area, the data obtaining section deletes the input data stored in the another storage area, and when plural pieces of input data are stored in one of the storage areas, the data obtaining section randomly obtains one piece of the input data from the plural input data.

(2)

The information processing device according to (1), wherein

the first function is a function that outputs 1 when the input data is larger than a threshold value, and outputs 0 when the input data is smaller than the threshold value, and

the threshold value is determined by a random number.

(3)

The information processing device according to (2), wherein,

in a case the input data is an S-dimensional vector (S≧2), the first function is a function which outputs 1 when an s-th dimension (s≦S) element included in the input data is larger than the threshold value, and outputs 0 when the s-th dimension element is smaller than the threshold value, and

the dimension number s is determined by a random number.

(4)

The information processing device according to (2) or (3), wherein a random number used for determining the threshold value is a uniform random number or a Gaussian random number.

(5)

An information processing device including:

a data storage section having M area groups including 2^{N} storage areas;

a calculation section that performs processing M times to obtain a piece of N-bit output data Q by inputting a piece of input data to a second function which includes N first functions randomly-outputting 0 or 1 and outputs a value output from a k-th (k=1 to N) first function as a k-th bit value;

a storing processing section that, when a piece of output data Q is obtained by the calculation section at m-th (m=1−M) time, stores the input data in a Q-th storage area in an m-th area group; and

a density calculation section that calculates the number of input data stored per storage area with respect to a storage area storing input data identical to the input data to be processed.

(6)

An information processing method including:

preparing M area groups including 2^{N} storage areas;

performing processing M times to obtain a piece of N-bit output data Q by inputting a piece of input data to a second function which includes N first functions randomly-outputting 0 or 1 and outputs a value output from a k-th (k=1 to N) first function as a k-th bit value;

storing the input data in a Q-th storage area in an m-th area group when a piece of output data Q is obtained at m-th (m=1 to M) time; and

obtaining input data stored in the storage area one after another until a predetermined number of input data is obtained, by scanning the storage area in a predetermined order,

wherein, in the obtaining step, when a piece of input data identical to the obtained input data is stored in another storage area, the input data stored in the another storage area is deleted, and when plural pieces of input data are stored in one of the storage areas, one piece of the input data is randomly obtained from the plural input data.

(7)

An information processing method including:

preparing M area groups including 2^{N} storage areas;

performing processing M times to obtain a piece of N-bit output data Q by inputting a piece of input data to a second function which includes N first functions randomly outputting 0 or 1 and outputs a value output from a k-th (k=1 to N) first function as a k-th bit value;

storing the input data in a Q-th storage area in an m-th area group when a piece of output data Q is obtained at m-th (m=1 to M) time; and

calculating the number of stored input data per storage area with respect to a storage area storing input data identical to the input data to be processed.

(8)

A program for causing a computer to realize:

a data storage function having M area groups including 2^{N} storage areas;

a calculation function to perform processing M times to obtain a piece of N-bit output data Q by inputting a piece of input data to a second function which includes N first functions randomly outputting 0 or 1 and outputs a value output from a k-th (k=1 to N) first function as a k-th bit value;

a storing processing function to store the input data in a Q-th storage area in an m-th area group when a piece of output data Q is obtained by the calculation function at m-th (m=1 to M) time; and

a data obtaining function to obtain input data stored in the storage area one after another by scanning the storage area in a predetermined order until a predetermined number of input data is obtained,

wherein, when a piece of input data identical to the obtained input data is stored in another storage area, the data obtaining function deletes the input data stored in the another storage area, and when plural pieces of input data are stored in one of the storage areas, the data obtaining function randomly obtains one piece of the input data from the plural input data.

(9)

A program for causing a computer to realize:

a data storage function having M area groups including 2^{N} storage areas;

a calculation function to perform processing M times to obtain a piece of N-bit output data Q by inputting a piece of input data to a second function which includes N first functions randomly outputting 0 or 1 and outputs a value output from a k-th (k=1−N) first function as a k-th bit value;

a storing processing function to store the input data in a Q-th storage area in an m-th area group when a piece of output data Q is obtained by the calculation function at m-th (m=1 to M) time; and

a density calculation function to calculate the number of input data stored per storage area with respect to a storage area storing input data identical to the input data to be processed.

(Note)

The above-described learning data integration section 124 is an example of the data storage section, the calculation section, the storing processing section, the data obtaining section, and the density calculation section. The bucket above-described is an example of the storage are. The above-described function h is an example of the first function. The above-described hash function g is an example of the second function.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Applications JP 2011-196300 and JP 2011-196301, both filed in the Japan Patent Office on Sep. 8, 2011, the entire content of which is hereby incorporated by reference.

What is claimed is:

1. An information processing device comprising:
a feature quantity vector calculation section that, when a plurality of pieces of learning data each configured including input data and an objective variable corresponding to the input data are given, inputs the input data into a plurality of basis functions to calculate feature quantity vectors which include output values from the respective basis functions as elements;
a distribution adjustment section that adjusts a distribution of points which are specified by the feature quantity vectors in a feature quantity space so that the distribution of the points becomes closer to a predetermined distribution; and
a function generation section that generates an estimation function which outputs an estimate value of the objective variable in accordance with input of the feature quantity vectors with respect to the plurality of pieces of learning data.

2. The information processing device according to claim 1, wherein the distribution adjustment section thins the learning data so that the distribution of the points which are specified by the feature quantity vectors in the feature quantity space becomes closer to the predetermined distribution.

3. The information processing device according to claim 1, wherein the distribution adjustment section weights each piece of the learning data so that the distribution of the points which are specified by the feature quantity vectors in the feature quantity space becomes closer to the predetermined distribution.

4. The information processing device according to claim 1, wherein the distribution adjustment section thins the learning data and weights each piece of the learning data remaining after thinning so that the distribution of the points which are specified by the feature quantity vectors in the feature quantity space becomes closer to the predetermined distribution.

5. The information processing device according to claim 1, wherein the predetermined distribution is a uniform distribution or a Gauss distribution.

6. The information processing device according to claim 2, wherein, when new learning data is additionally given, the distribution adjustment section thins a learning data group including the new learning data and the existing learning data so that the distribution of the points which are specified by the feature quantity vectors in the feature quantity space becomes closer to the predetermined distribution.

7. The information processing device according to claim 1, further comprising:
a basis function generation section that generates the basis function by combining a plurality of previously prepared functions.

8. The information processing device according to claim 7, wherein
the basis function generation section updates the basis function based on a genetic algorithm,
when the basis function is updated, the feature quantity vector calculation section inputs the input data into the updated basis function to calculate a feature quantity vector, and
the function generation section generates an estimation function which outputs an estimate value of the objective variable in accordance with input of the feature quantity vector which is calculated using the updated basis function.

9. An estimator generating method comprising:
inputting, when a plurality of pieces of learning data each configured including input data and objective variables corresponding to the input data are given, the input data into a plurality of basis functions to calculate feature quantity vectors which include output values from the respective basis functions as elements;
adjusting a distribution of points which are specified by the feature quantity vectors in a feature quantity space so that the distribution of the points becomes closer to a predetermined distribution; and
generating an estimation function which outputs estimate values of the objective variables in accordance with input of the feature quantity vectors with respect to the plurality of pieces of learning data.

10. A program for causing a computer to realize:
a feature quantity vector calculation function that, when a plurality of pieces of learning data each configured including input data and an objective variable corresponding to the input data are given, inputs the input data into a plurality of basis functions to calculate feature quantity vectors which include output values from the respective basis functions as elements;
a distribution adjustment function that adjusts a distribution of points which are specified by the feature quantity vectors in a feature quantity space so that the distribution of the points becomes closer to a predetermined distribution; and
a function generation function that generates an estimation function which outputs an estimate value of the objective variable in accordance with input of the feature quantity vectors with respect to the plurality of pieces of learning data.
